(19) United States
(12) Patent Application Publication
(10) Pub. No.: US 2025/0370475 A1
(43) Pub. Date: Dec. 4, 2025

(54) APPLYING ENTRY EDGES IN A COVERED ENVIRONMENT

(71) Applicant: Crown Equipment Corporation, New Bremen, OH (US)

(72) Inventors: Benjamin Morelli, Auckland (NZ); Ryan Estep, Auckland (NZ); Dustin Seger, Sharonville, OH (US); Dave Seger, Versailles, OH (US); Mike Corbett, Macedonia, OH (US); Mark Addison, Ludlow Falls, OH (US); Gary Wolters, Coldwater, OH (US); Jamison Frady, New Bremen, OH (US); Matt Niekamp, Celina, OH (US)

(73) Assignee: Crown Equipment Corporation, New Bremen, OH (US)

(21) Appl. No.: 19/219,418

(22) Filed: May 27, 2025

Related U.S. Application Data
(60) Provisional application No. 63/654,709, filed on May 31, 2024.

(51) Int. Cl. G05D 1/65; B66F 9/075; G05D 1/617; G05D 105/28; G05D 107/70

(52) U.S. Cl. CPC G05D 1/65; B66F 9/0755; G05D 1/617; G05D 2105/28; G05D 2107/70

(57) ABSTRACT

Embodiments provided include a method that includes determining a location of a restriction zone, where the restriction zone includes a first edge and a second edge, providing a user option to independently define a first policy for a materials handling vehicle when crossing into the restriction zone via the first edge and a second policy for the materials handling vehicle when crossing into the restriction zone via the second edge, and receiving user input defining the first policy and the second policy. Some embodiments include determining a location and an orientation from the materials handling vehicle, determining from the location and the orientation, that the materials handling vehicle is approaching the restriction zone via the first edge or the second edge, and communicating first policy data related to the first policy to the materials handling vehicle. Some embodiments include in response to determining communicating second policy data related to the second policy to the materials handling vehicle.

### CROSS REFERENCE

This application claims the benefit of U.S. Provisional Application Ser. No. 63/654,709 filed May 31, 2024, which is hereby incorporated by reference in its entirety.

### BACKGROUND

Vehicles that operate in covered environments, such as warehouses are often required to maneuver and traverse tights spaces. Many of the vehicles being used in these types of environments include forklifts, trailers, and/or other components that may be required to reduce speed and provide other measures because other vehicles, pedestrians, or obstacles may be in the vicinity. In an order to provide environment-wide or enterprise-wide continuity to these high traffic areas, administrators often create restriction zones, which are predetermined areas in an environment and/or across an enterprise that have a rule by which a vehicle that enters that restriction zone must comply.

Current solutions may utilize static zones that cause the vehicle to reduce speed or take other action. While these current solutions have improved some aspects of the vehicle operation, these current solutions lack the ability to detect, alert, and avoid many objects that that the vehicle encounters in the environment, while maintaining operational efficiencies. As such, a need in the industry exists for improved zone creation and functionality.

### SUMMARY

Systems and methods for providing a zone are described. A first aspect includes a system comprising: a materials handling vehicle in a covered environment that includes a vehicle transceiver for detecting a location of the materials handling vehicle in the covered environment, a vehicle sensor for detecting an orientation of the materials handling vehicle and a vehicle computing device; a remotely located computing device that includes a processor and a memory component, the memory component storing logic that, when executed by the processor, causes the system to perform at least the following: determine, from the location and the orientation, that the materials handling vehicle is approaching a restriction zone, wherein the restriction zone includes an entrance edge and an exit edge; and provide to the materials handling vehicle a distance to the restriction zone and a policy of the restriction zone; wherein the vehicle computing device determines a characteristic of the materials handling vehicle that affects compliance with the policy, wherein the vehicle computing device determines a first adjustment to current operation of the materials handling vehicle to comply with the policy; wherein the vehicle computing device determines, based on the policy and the first adjustment, a distance to begin the first adjustment to comply with the policy at the entrance edge of the restriction zone; and wherein the vehicle computing device causes the materials handling vehicle to make the first adjustment to comply with the policy at the entrance edge of the restriction zone.

A second aspect includes the first aspect, wherein the vehicle sensor includes at least one of the following: a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a 4-dimensional LiDAR system, a RADAR system, a SONAR system, or a camera system.

A third aspect includes the first aspect and/or the second aspect, wherein the vehicle transceiver includes an ultra wide band (UWB) transceiver that communicates with a plurality of UWB transceiver anchors that are fixed to stationary objects in the covered environment for detecting the location of the materials handling vehicle in the covered environment.

A fourth aspect includes any of the first aspect through the third aspect, wherein the policy includes at least one of the following: a speed policy, a platform height policy, a hoist speed policy, an acceleration policy, a deceleration policy, or a fork height policy.

A fifth aspect includes any of the first aspect through the fourth aspect, wherein the vehicle computing device further determines a second adjustment to return vehicle operation to the current operation of the materials handling vehicle, and wherein the vehicle computing device returns vehicle operation to the current operation at the exit edge of the restriction zone.

A sixth aspect includes any of the first aspect through the fifth aspect, wherein the characteristic includes at least one of the following: a current speed, a vehicle weight, a payload weight, a deceleration rate, a vehicle type, a vehicle model, a fork maximum height, a platform height, or a hoist speed.

A seventh aspect includes any of the first aspect through the sixth aspect, wherein the remotely located computing device includes at least one of the following: a local computing device that resides in the covered environment and a remote computing device that resides remote from the covered environment.

An eighth aspect includes a method comprising sending, by a vehicle computing device, location data and orientation data from a materials handling vehicle that operates in a covered environment to a remotely located computing device; receiving, by the vehicle computing device, a distance of the materials handling vehicle to a restriction zone and a policy of the restriction zone, wherein the distance and the policy are determined by the remotely located computing device from the location data and the orientation data and wherein the restriction zone includes an entrance edge and an exit edge; determining, by the vehicle computing device, a characteristic of the materials handling vehicle that affects compliance with the policy, determining, by the vehicle computing device, a first adjustment to current operation of the materials handling vehicle to comply with the policy; determining, by the vehicle computing device, based on the policy and the first adjustment, a distance to begin the first adjustment to comply with the policy at the entrance edge of the restriction zone; and causing, by the vehicle computing device, the materials handling vehicle to make the first adjustment to comply with the policy at the entrance edge of the restriction zone.

A ninth aspect includes the eighth aspect, wherein the orientation data is received from a vehicle sensor that includes at least one of the following: a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a 4-dimensional LiDAR system, a RADAR system, a SONAR system, or a camera system.

A tenth aspect includes the eighth aspect and/or the ninth aspect, wherein the location data is received via an ultra wide band (UWB) transceiver that communicates with a plurality of UWB transceiver anchors that are fixed to stationary objects in the covered environment for detecting a location of the materials handling vehicle in the covered environment.

An eleventh aspect includes any of the eighth aspect through the tenth aspect, wherein the policy includes at least one of the following: a speed policy, a platform height policy, a hoist speed policy, an acceleration policy, a deceleration policy, or a fork height policy.

A twelfth aspect includes any of the eighth aspect through the eleventh aspect, wherein the vehicle computing device further determines a second adjustment to return vehicle operation to the current operation of the materials handling vehicle, and wherein the vehicle computing device returns vehicle operation to the current operation at the exit edge of the restriction zone.

A thirteenth aspect includes any of the eighth aspect through the twelfth aspect, wherein the characteristic includes at least one of the following: a current speed, a vehicle weight, a payload weight, a deceleration rate, a vehicle type, a vehicle model, a fork maximum height, a platform height, or a hoist speed.

A fourteenth aspect includes any of the eighth aspect through the thirteenth aspect, wherein the remotely located computing device includes at least one of the following: a local computing device that resides in the covered environment and a remote computing device that resides remote from the covered environment.

A fifteenth aspect includes a materials handling vehicle comprising: a vehicle sensor for detecting sensor data; a vehicle transceiver for communicating with a remotely located computing device; and a vehicle computing device that includes a vehicle processor and a vehicle memory component that stores logic that, when executed by the vehicle processor, causes the materials handling vehicle to perform at least the following: send the sensor data from the materials handling vehicle that operates in a covered environment to the remotely located computing device; receive, via the vehicle transceiver, a distance of the materials handling vehicle to a restriction zone and a policy of the restriction zone from the remotely located computing device via the vehicle transceiver, wherein the distance and the policy are determined by the remotely located computing device from the sensor data and wherein the restriction zone includes an entrance edge and an exit edge; determine a characteristic of the materials handling vehicle that affects compliance with the policy, determine a first adjustment to current operation of the materials handling vehicle to comply with the policy; determine, based on the policy and the first adjustment, a distance to begin the first adjustment to comply with the policy at the entrance edge of the restriction zone; and cause the materials handling vehicle to make the first adjustment to comply with the policy at the entrance edge of the restriction zone.

A sixteenth aspect includes the fifteenth aspect, wherein the vehicle sensor includes at least one of the following: a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a 4-dimensional LiDAR system, a RADAR system, a SONAR system, or a camera system.

A seventeenth aspect includes the fifteenth aspect and/or the sixteenth aspect, wherein the vehicle transceiver includes an ultra wide band (UWB) transceiver that communicates with a plurality of UWB transceiver anchors that are fixed to stationary objects in the covered environment for detecting a location of the materials handling vehicle in the covered environment.

An eighteenth aspect includes any of the fifteenth aspect through the seventeenth aspect, wherein the policy includes at least one of the following: a speed policy, a platform height policy, a hoist speed policy, an acceleration policy, a deceleration policy, or a fork height policy.

A nineteenth aspect includes any of the fifteenth aspect through the eighteenth aspect, wherein the vehicle computing device further determines a second adjustment to return vehicle operation to the current operation of the materials handling vehicle, and wherein the vehicle computing device returns vehicle operation to the current operation at the exit edge of the restriction zone.

A twentieth aspect includes any of the fifteenth aspect through nineteenth aspect, wherein the characteristic includes at least one of the following: a current speed, a vehicle weight, a payload weight, a deceleration rate, a vehicle type, a vehicle model, a fork maximum height, a platform height, or a hoist speed.

A twenty-first aspect includes a system comprising: a materials handling vehicle in a covered environment that includes a vehicle transceiver for determining a location of the materials handling vehicle in the covered environment, a vehicle sensor for detecting an orientation of the materials handling vehicle and a vehicle computing device; a remotely located computing device that includes a processor and a memory component, the memory component storing logic that, when executed by the processor, causes the system to perform at least the following: determine a location of a restriction zone in the covered environment, wherein the restriction zone includes a first edge and a second edge; provide a user option to independently define a first policy for the materials handling vehicle when crossing into the restriction zone via the first edge and a second policy for the materials handling vehicle when crossing into the restriction zone via the second edge; receive user input defining the first policy and the second policy; determine the location and the orientation from the materials handling vehicle; determine, from the location and the orientation, that the materials handling vehicle is approaching the restriction zone via the first edge or the second edge; in response to determining that the materials handling vehicle is approaching the restriction zone via the first edge, communicate first policy data related to the first policy to the materials handling vehicle; and in response to determining that the materials handling vehicle is approaching the restriction zone via the second edge, communicate second policy data related to the second policy to the materials handling vehicle, wherein, if the materials handling vehicle is approaching the restriction zone via the first edge, the materials handling vehicle adjusts current operation pursuant to the first policy data to adhere to the first policy prior to reaching the first edge and if the materials handling vehicle is approaching the restriction zone via the second edge, the materials handling vehicle adjusts current operation pursuant to the second policy data to adhere to the second policy prior to reaching the second edge.

A twenty-second aspect includes the twenty-first aspect, wherein in response to determining that the materials handling vehicle is approaching the restriction zone via the first edge, the logic causes the system to send first distance data related to a distance from the first edge to the materials handling vehicle, and wherein in response to determining that the materials handling vehicle is approaching the restriction zone via the second edge, the logic causes the system to send second distance data related to a distance from the second edge to the materials handling vehicle.

A twenty-third aspect includes the twenty-first aspect and/or the twenty-second aspect, wherein the vehicle sensor includes at least one of the following: a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a 4-dimensional LiDAR system, a RADAR system, a SONAR system, or a camera system.

A twenty-fourth aspect includes any of the twenty-first aspect through the twenty-third aspect, wherein the vehicle transceiver includes an ultra wide band (UWB) antenna that communicates with a plurality of UWB transceiver anchors that are fixed to stationary objects in the covered environment for detecting the location of the materials handling vehicle in the covered environment.

A twenty-fifth aspect includes aspect includes any of the twenty-first aspect through the twenty-fourth aspect, wherein the first policy includes at least one of the following: a speed policy, a platform height policy, a hoist speed policy, an acceleration policy, a deceleration policy, or a fork height policy.

A twenty-sixth aspect includes any of the twenty-first aspect through the twenty-fifth aspect, wherein in response to determining that the materials handling vehicle will enter the restriction zone via the first edge, the materials handling vehicle determines a first policy associated with a deceleration rate and utilizes first policy data that includes the deceleration rate to determine when to start decelerating to comply with the first policy by the first edge.

A twenty-seventh aspect includes any of the twenty-first aspect through the twenty-sixty aspect, wherein the materials handling vehicle further determines at least one of the following in determining the deceleration rate: a payload weight of a payload carried by the materials handling vehicle, a vehicle type of the materials handling vehicle, or a weight of the materials handling vehicle.

A twenty-eighth aspect includes any of the twenty-first aspect through the twenty-seventh aspect, wherein the remotely located computing device includes at least one of the following: a local computing device that resides in the covered environment and a remote computing device that resides remote from the covered environment.

A twenty-ninth aspect includes any of the twenty-first aspect through the twenty-eighth aspect, wherein the user option is provided as part of a user interface that includes an add option to perform at least one of the following: add additional restriction zones in the covered environment or add new policies for other edges.

A thirtieth aspect includes any of the twenty-first aspect through the twenty-ninth aspect, wherein the first policy provides a default characteristic that the materials handling vehicle will comply, even after the materials handling vehicle exits the restriction zone and wherein the second policy removes the default characteristic when the materials handling vehicle crosses the second edge.

A thirty-first aspect includes a method comprising: determining, by a computing device, a location of a restriction zone in a covered environment, wherein the restriction zone includes a first edge and a second edge; providing, by the computing device, a user option to independently define a first policy for a materials handling vehicle when crossing into the restriction zone via the first edge and a second policy for the materials handling vehicle when crossing into the restriction zone via the second edge; receiving, by the computing device, user input defining the first policy and the second policy; determining, by the computing device, a location and an orientation from the materials handling vehicle; determining, by the computing device, from the location and the orientation, that the materials handling vehicle is approaching the restriction zone via the first edge or the second edge; in response to determining that the materials handling vehicle is approaching the restriction zone via the first edge, communicating, by the computing device, first policy data related to the first policy to the materials handling vehicle; and in response to determining that the materials handling vehicle is approaching the restriction zone via the second edge, communicating, by the computing device, second policy data related to the second policy to the materials handling vehicle, wherein, if the materials handling vehicle is approaching the restriction zone via the first edge, the materials handling vehicle adjusts current operation pursuant to the first policy data to adhere to the first policy prior to reaching the first edge and if the materials handling vehicle is approaching the restriction zone via the second edge, the materials handling vehicle adjusts current operation pursuant to the second policy data to adhere to the second policy prior to reaching the second edge.

A thirty-second aspect includes the thirty-first aspect, further comprising: in response to determining that the materials handling vehicle is approaching the restriction zone via the first edge, sending first distance data related to a distance from the first edge to the materials handling vehicle; and in response to determining that the materials handling vehicle is approaching the restriction zone via the second edge, sending second distance data related to a distance from the second edge to the materials handling vehicle.

A thirty-third aspect includes the thirty-first aspect and/or the thirty-second aspect, wherein the orientation is determined via at least one vehicle sensor that includes at least one of the following: a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a 4-dimensional LiDAR system, a RADAR system, a SONAR system, or a camera system.

A thirty-fourth aspect includes any of the thirty-first aspect through the thirty-third aspect, wherein determining the location includes communicating with an ultra wide band (UWB) antenna on the materials handling vehicle that communicates with a plurality of UWB transceiver anchors that are fixed to stationary objects in the covered environment for detecting the location of the materials handling vehicle in the covered environment.

A thirty-fifth aspect includes any of the thirty-first aspect through the thirty-fourth aspect, wherein the first policy includes at least one of the following: a speed policy, a platform height policy, a hoist speed policy, an acceleration policy, a deceleration policy, or a fork height policy.

A thirty-sixth aspect includes any of the thirty-first aspect through the thirty-fifth aspect, wherein in response to determining that the materials handling vehicle will enter the restriction zone via the first edge, the materials handling vehicle determines a first policy associated with a deceleration rate and utilizes first policy data that includes the deceleration rate to determine when to start decelerating to comply with the first policy by the first edge.

A thirty-seventh aspect includes any of the thirty-first aspect through the thirty-sixth aspect, wherein the materials handling vehicle further determines at least one of the following in determining the deceleration rate: a payload weight of a payload carried by the materials handling vehicle, a vehicle type of the materials handling vehicle, or a weight of the materials handling vehicle.

A thirty-eighth aspect includes a system comprising: a remotely located computing device that includes a processor and a memory component, the memory component storing logic that, when executed by the processor, causes the system to perform at least the following: determine a location of a restriction zone in a covered environment, wherein the restriction zone includes a first edge and a second edge; provide a user option to independently define a first policy for a materials handling vehicle when crossing into the restriction zone via the first edge and a second policy for the materials handling vehicle when crossing into the restriction zone via the second edge; receive user input defining the first policy and the second policy; determine a location and an orientation from data received from the materials handling vehicle; determine, from the location and the orientation, that the materials handling vehicle is approaching the restriction zone via the first edge or the second edge; in response to determining that the materials handling vehicle is approaching the restriction zone via the first edge, communicate first policy data related to the first policy to the materials handling vehicle; and in response to determining that the materials handling vehicle is approaching the restriction zone via the second edge, communicate second policy data related to the second policy to the materials handling vehicle, wherein, if the materials handling vehicle is approaching the restriction zone via the first edge, the materials handling vehicle adjusts current operation pursuant to the first policy data to adhere to the first policy prior to reaching the first edge and if the materials handling vehicle is approaching the restriction zone via the second edge, the materials handling vehicle adjusts current operation pursuant to the second policy data to adhere to the second policy prior to reaching the second edge.

A thirty-ninth aspect includes the thirty-eighth aspect, wherein: the materials handling vehicle includes a vehicle transceiver for determining the location of the materials handling vehicle in the covered environment, the vehicle transceiver includes an ultra wide band (UWB) antenna that communicates with a plurality of UWB transceiver anchors that are fixed to stationary objects in the covered environment for detecting the location of the materials handling vehicle in the covered environment, the materials handling vehicle includes a vehicle sensor for detecting the orientation of the materials handling vehicle and a vehicle computing device, and the vehicle sensor includes at least one of the following: a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a 4-dimensional LiDAR system, a RADAR system, a SONAR system, or a camera system.

A fortieth aspect includes the thirty-eighth aspect and/or the thirty ninth aspect, wherein the user option is provided as part of a user interface that includes an add option to perform at least one of the following: add additional restriction zones in the covered environment or add new policies for other edges restriction zones in the covered environment.

A forty-first aspect includes a system comprising: a materials handling vehicle in a covered environment that includes a vehicle transceiver for determining a location of the materials handling vehicle in the covered environment, a vehicle sensor for detecting an orientation of the materials handling vehicle and a vehicle computing device; a remotely located computing device that includes a processor and a memory component, the memory component storing logic that, when executed by the processor, causes the system to perform at least the following: create a first restriction zone for the covered environment, wherein the first restriction zone defines an area within which the materials handling vehicle must comply with a first policy; define the first policy; define a second policy for the first restriction zone; create the first restriction zone; determine the location and the orientation of the materials handling vehicle; determine, from the location and the orientation, that the materials handling vehicle is approaching the first restriction zone; and in response to determining that the materials handling vehicle is approaching the first restriction zone, determine whether the first policy applies to the materials handling vehicle and, in response to determining that the first policy applies to the materials handling vehicle, send data related to the first policy to the materials handling vehicle, which causes the materials handling vehicle to adjust operation to comply with the first policy when the materials handling vehicle enters the first restriction zone.

A forty-second aspect includes the forty-first aspect, wherein in response to determining that the materials handling vehicle is approaching the first restriction zone, the logic causes the system to determine whether the second policy applies to the materials handling vehicle.

A forty-third aspect includes the forty-first aspect and/or the forty-second aspect, wherein in response to determining that the second policy applies to the materials handling vehicle, the logic causes the system to perform the following: determine whether the first policy and the second policy are compatible; in response to determining that the first policy and the second policy are compatible, send the materials handling vehicle the second policy, which causes the materials handling vehicle to adjust operation to also comply with the second policy when the materials handling vehicle enters the first restriction zone; in response to determining that the first policy and the second policy are not compatible, determine which of the first policy and the second policy has priority and apply only a higher priority policy.

A forty-fourth aspect includes any of the forty-first aspect through the forty-third aspect, wherein the vehicle sensor includes at least one of the following: a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a 4-dimensional LiDAR system, a RADAR system, a SONAR system, or a camera system.

A forty-fifth aspect includes any of the forty-first aspect through the forty-fourth aspect, wherein the vehicle transceiver includes an ultra wide band (UWB) transceiver that communicates with a plurality of UWB transceiver anchors that are fixed to stationary objects in the covered environment for detecting the location of at least one of the following in the covered environment: the materials handling vehicle, a person, or an object.

A forty-sixth aspect includes any of the forty-first aspect through the forty-fifth aspect, wherein the first policy includes at least one of the following: a speed policy, a platform height policy, a hoist speed policy, an acceleration policy, a deceleration policy, or a fork height policy.

A forty-seventh aspect includes any of the forty-first aspect through the forty-sixth aspect, wherein the logic further causes the system to perform least the following: create a second restriction zone; determine whether the first restriction zone and the second restriction zone should be combined, wherein determining whether the first restriction zone and the second restriction zone should be combined includes determining proximity of the first restriction zone relative to the second restriction zone; and in response to determining that the first restriction zone and the second restriction zone should be combined, combine the first restriction zone with the second restriction zone.

A forty-eighth aspect includes any of the forty-first aspect through the forty-seventh aspect, wherein creating the second restriction zone includes determining a third policy to apply to the second restriction zone and wherein determining whether the first restriction zone should be combined with the second restriction zone further includes comparing whether the third policy is compatible with at least one of the following: the first policy or the second policy.

A forty-ninth aspect includes a method comprising: creating, by a computing device, a first restriction zone for a covered environment, wherein the first restriction zone defines an area within which a materials handling vehicle must comply with a first policy; defining, by the computing device, the first policy; defining, by the computing device, a second policy for the first restriction zone; determining, by the computing device, a location and an orientation of the materials handling vehicle; determining, by the computing device, from the location and the orientation, that the materials handling vehicle is approaching the first restriction zone; and in response to determining that the materials handling vehicle is approaching the first restriction zone, determining, by the computing device, whether the first policy applies to the materials handling vehicle and, in response to determining that the first policy applies to the materials handling vehicle, sending, by the computing device, the materials handling vehicle the first policy, which causes the materials handling vehicle to adjust current operation to comply with the first policy when the materials handling vehicle enters the first restriction zone.

A fiftieth aspect includes the forty-ninth aspect, further comprising, in response to determining that the materials handling vehicle is approaching the first restriction zone, determining whether the second policy applies to the materials handling vehicle.

A fifty-first aspect includes the forty-ninth aspect and/or the fiftieth aspect, in response to determining that the second policy applies to the materials handling vehicle, determining whether the first policy and the second policy are compatible.

A fifty-second aspect includes any of the forty-ninth aspect through the fifty-first aspect, in response to determining that the first policy and the second policy are compatible, sending the materials handling vehicle the second policy, which causes the materials handling vehicle to adjust current operation to comply with the second policy when the materials handling vehicle enters the first restriction zone.

A fifty-third aspect includes any of the forty-ninth aspect through the fifty-second aspect, wherein the orientation is determined via at least one vehicle sensor that includes at least one of the following: a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a 4-dimensional LiDAR system, a RADAR system, a SONAR system, or a camera system.

A fifty-fourth aspect includes any of the forty-ninth aspect through the fifty-third aspect, wherein the vehicle transceiver includes an ultra wide band (UWB) transceiver that communicates with a plurality of UWB transceiver anchors that are fixed to stationary objects in the covered environment for detecting the location of at least one of the following in the covered environment: the materials handling vehicle, a person, or an object.

A fifty-fifth aspect includes any of the forty-ninth aspect through the fifty-fourth aspect, wherein the first policy includes at least one of the following: a speed policy, a platform height policy, a hoist speed policy, an acceleration policy, a deceleration policy, or a fork height policy.

A fifty-sixth aspect includes any of the forty-ninth aspect through the fifty-fifth aspect, further comprising: creating a second restriction zone; determining whether the first restriction zone and the second restriction zone should be combined, wherein determining whether the first restriction zone and the second restriction zone should be combined includes determining proximity of the first restriction zone relative to the second restriction zone; and in response to determining that the first restriction zone and the second restriction zone should be combined, combining the first restriction zone with the second restriction zone, wherein creating the second restriction zone includes determining a third policy to apply to the second restriction zone and wherein determining whether the first restriction zone should be combined with the second restriction zone further includes comparing whether the third policy is compatible with at least one of the following: the first policy or the second policy.

A fifty-seventh aspect includes a system comprising: a remotely located computing device that includes a processor and a memory component, the memory component storing logic that, when executed by the processor, causes the system to perform at least the following: create a first restriction zone for a covered environment, wherein the first restriction zone defines an area within which a materials handling vehicle must comply with a first policy; define the first policy; define a second policy for the first restriction zone; determine a location and an orientation of the materials handling vehicle; determine, from the location and the orientation, that the materials handling vehicle is approaching the first restriction zone; and in response to determining that the materials handling vehicle is approaching the first restriction zone, determine whether the first policy applies to the materials handling vehicle and, in response to determining that the first policy applies to the materials handling vehicle, send the materials handling vehicle the first policy, which causes the materials handling vehicle to adjust current operation to comply with the first policy when the materials handling vehicle enters the first restriction zone.

A fifty-eighth aspect includes the fifty-seventh aspect, wherein in response to determining that the materials handling vehicle is approaching the first restriction zone, the logic causes the system to determine whether the second policy applies to the materials handling vehicle, wherein in response to determining that the second policy applies to the materials handling vehicle, the logic causes the system to determine whether the first policy and the second policy are compatible, and in response to determining that the first policy and the second policy are compatible, the logic causes the system to send the materials handling vehicle the second policy, which causes the materials handling vehicle to adjust current operation to comply with the second policy when the materials handling vehicle enters the first restriction zone.

A fifty-ninth aspect includes the fifty-seventh aspect and/or the fifty-eighth aspect, wherein the logic further causes the system to perform at least the following: create a second restriction zone; determine whether the first restriction zone and the second restriction zone should be combined, wherein determining whether the first restriction zone and the second restriction zone should be combined includes determining proximity of the first restriction zone relative to the second restriction zone; and in response to determining that the first restriction zone and the second restriction zone should be combined, combine the first restriction zone with the second restriction zone.

A sixtieth aspect includes any of the fifty-seventh aspect through the fifty-ninth aspect, wherein creating the second restriction zone includes determining a third policy to apply to the second restriction zone and wherein determining whether the first restriction zone should be combined with the second restriction zone further includes comparing whether the third policy is compatible with at least one of the following: the first policy or the second policy.

A sixty-first aspect includes a system comprising: a materials handling vehicle in a first covered environment; a remote computing device that includes a processor and a memory component, the memory component storing logic that, when executed by the processor, causes the system to perform at least the following: create a first policy that is available for applying to a potential restriction zone in the first covered environment and a second covered environment; define a rule for the first policy; create a zone category for the first policy; and a first local computing device that is configured for serving the first covered environment that includes a local processor and a local memory component, the local memory component storing local logic that, when executed by the local processor, causes the system to perform at least the following: create a first restriction zone for the first covered environment, wherein creating the first restriction zone includes defining the zone category for the first restriction zone and a location for the first restriction zone; determine whether the zone category matches the zone category for the first policy; in response to determining that the zone category matches the zone category for the first policy, apply the first policy to the first restriction zone; and in response to determining that the materials handling vehicle is approaching the first restriction zone, apply the first policy.

A sixty-second aspect includes the sixty-first aspect, wherein the first local computing device sends an exception request to the first policy to the remote computing device and wherein the remote computing device determines whether to grant the exception request.

A sixty-third aspect includes the sixty-first aspect and/or the sixty-second aspect, wherein in response to determining to grant the exception request, the remote computing device creates a second policy and provides access to the second policy only to the first local computing device.

A sixty-fourth aspect includes any of the sixty-first aspect through the sixty-third aspect, wherein in response to determining to grant the exception request, the remote computing device alters the first policy.

A sixty-fifth aspect includes any of the sixty-first aspect through the sixty-fourth aspect, wherein the remote computing device further grants access to the first policy to the first local computing device.

A sixty-sixth aspect includes any of the sixty-first aspect through the sixty-fifth aspect, further comprising a second local computing device that serves the second covered environment, wherein the second local computing device is granted access to the first policy for use in the second covered environment.

A sixty-seventh aspect includes any of the sixty-first aspect through the sixty-sixth aspect, wherein the zone category includes at least one of the following: a high traffic area, a pedestrian area, a truck-specific area, or an end of aisle area.

A sixty-eighth aspect includes a method comprising: creating, by a computing device, a first policy that is available for applying to a potential restriction zone in a first covered environment and a second covered environment; defining, by the computing device, a rule for the first policy; creating, by the computing device, a zone category for the first policy; creating, by the computing device, a first restriction zone for the first covered environment, wherein creating the first restriction zone includes defining the zone category for the first restriction zone and a location for the first restriction zone; determining, by the computing device, whether the zone category matches the zone category for the first policy; in response to determining that the zone category matches the zone category for the first policy, applying, by the computing device, the first policy to the first restriction zone; and in response to determining that a materials handling vehicle is approaching the first restriction zone, applying, by the computing device, the first policy.

A sixty-ninth aspect includes the sixty-eighth aspect, further comprising: receiving an exception request to create an exception to the first policy for the first covered environment; and determining whether to grant the exception request.

A seventieth aspect includes the sixty-eighth aspect and/or the sixty-ninth aspect, further comprising in response to determining to grant the exception request, creating a second policy and providing access to the second policy only to a first local computing device that serves the first covered environment.

A seventy-first aspect includes any of the sixty-eighth aspect through the seventieth aspect, further comprising in response to determining to grant the exception request, altering the first policy.

A seventy-second aspect includes any of the sixty-eighth aspect through the seventy-first aspect, further comprising granting access to the first policy to a first local computing device for application to the first covered environment.

A seventy-third aspect includes any of the sixty-eighth aspect through the seventy-second aspect, further comprising granting access to the first policy to a second local computing device that serves the second covered environment, such that the first policy may be used in the second covered environment.

A seventy-fourth aspect includes any of the sixty-eighth aspect through the seventy-third aspect, wherein the zone category includes at least one of the following: a high traffic area, a pedestrian area, a truck-specific area, or an end of aisle area.

A seventy-fifth aspect includes a system comprising: a remote computing device that includes a processor and a memory component, the memory component storing logic that, when executed by the processor, causes the system to perform at least the following: create a first policy that is available for applying to a potential restriction zone in a first covered environment and a second covered environment; define a rule for the first policy; create a zone category for the first policy; and a first local computing device that is configured for serving the first covered environment that includes a local processor and a local memory component, the local memory component storing local logic that, when executed by the local processor, causes the system to perform at least the following: create a first restriction zone for the first covered environment, wherein creating the first restriction zone includes defining the zone category for the first restriction zone and a location for the first restriction zone; determine whether the zone category matches the zone category for the first policy; in response to determining that the zone category matches the zone category for the first policy, apply the first policy to the first restriction zone; and in response to determining that a materials handling vehicle is approaching the first restriction zone, apply the first policy.

A seventy-sixth aspect includes the seventy-fifth aspect, wherein the first local computing device sends an exception request to the first policy to the remote computing device and wherein the remote computing device determines whether to grant the exception request.

A seventy-seventh aspect includes the seventy-fifth aspect and/or the seventy-sixth aspect, wherein in response to determining to grant the exception request, the remote computing device creates a second policy and provides access to the second policy only to the first local computing device.

A seventy-eighth aspect includes any of the seventy-fifth aspect through the seventy-seventh aspect, wherein in response to determining to grant the exception request, the remote computing device alters the first policy.

A seventy-ninth aspect includes any of the seventy-fifth aspect through the seventy-eighth aspect, further comprising a second local computing device that serves the second covered environment, wherein the second local computing device is granted access to the first policy for use in the second covered environment.

An eightieth aspect includes any of the seventy-fifth aspect through the seventy-ninth aspect, wherein the zone category includes at least one of the following: a high traffic area, a pedestrian area, a truck-specific area, or an end of aisle area.

An eighty-first aspect includes a system comprising: a materials handling vehicle in a covered environment that includes a vehicle transceiver for determining a location of the materials handling vehicle in the covered environment, a vehicle sensor for detecting an orientation of the materials handling vehicle and a vehicle computing device; a remotely located computing device that includes a processor and a memory component, the memory component storing logic that, when executed by the processor, causes the system to perform at least the following: create a temporal-based restriction zone for the covered environment, wherein the temporal-based restriction zone defines an area within which the materials handling vehicle must comply with a policy; define the policy; define a first time that the policy applies; determine the location of the materials handling vehicle via the vehicle transceiver and the orientation of the materials handling vehicle via the vehicle sensor; determine, from the location and the orientation, that the materials handling vehicle is approaching the temporal-based restriction zone; determine whether a current time corresponds with the first time the policy applies; and in response to determining that the materials handling vehicle is approaching the temporal-based restriction zone at the first time the policy applies, send data related to the policy to the materials handling vehicle, which causes the materials handling vehicle to adjust operation to comply with the policy when the materials handling vehicle enters the temporal-based restriction zone.

An eighty-second aspect includes the eighty-first aspect, wherein in response to determining that the materials handling vehicle is approaching the temporal-based restriction zone at a different time than the first time the policy applies, the logic causes the system to allow the materials handling vehicle to enter the temporal-based restriction zone without interference.

An eighty-third aspect includes the eighty-first aspect and/or the eighty-second aspect, wherein the logic causes the system to determine a second time that the policy applies.

An eighty-fourth aspect includes any of the eighty-first aspect through the eighty-third aspect, wherein the policy includes a first rule that applies to the first time and a second rule that applies to the second time.

An eighty-fifth aspect includes any of the eighty-first aspect through the eighty-fourth aspect, wherein the vehicle transceiver includes an ultra wide band (UWB) antenna that communicates with a plurality of UWB anchors that are fixed to stationary objects in the covered environment for detecting the location of the materials handling vehicle in the covered environment.

An eighty-sixth aspect includes any of the eighty-first aspect through the eighty-fifth aspect, wherein the policy includes at least one of the following: a speed rule or a fork height rule.

An eighty-seventh aspect includes any of the eighty-first aspect through the eighty-sixth aspect, wherein the policy includes a time variable component that applies a first rule of the policy if the materials handling vehicle enters the temporal-based restriction zone during the first time, only if an other criteria is met.

An eighty-eighth aspect includes any of the eighty-first aspect through the eighty-eighth aspect, wherein the other criteria includes at least one of the following: a pedestrian congestion of a predefined area around the temporal-based restriction zone, a vehicle congestion of the predefined area around the temporal-based restriction zone, a condition of the materials handling vehicle, or a skill level of an operator of the materials handling vehicle.

An eighty-ninth aspect includes any of the eighty-first aspect through the eighty-eighth aspect, wherein the policy is specific to at least one of the following: a vehicle type, or the covered environment.

A ninetieth aspect includes a method comprising: creating, by a remotely located computing device, a temporal-based restriction zone for a covered environment, wherein the temporal-based restriction zone defines an area within which a materials handling vehicle must comply with a policy; defining, by the remotely located computing device, the policy; defining, by the remotely located computing device, a first time that the policy applies; determining, by the remotely located computing device, a location and an orientation of the materials handling vehicle; determining, by the remotely located computing device, from the location and the orientation, that the materials handling vehicle is approaching the temporal-based restriction zone; determining, by the remotely located computing device, whether a current time corresponds with the first time the policy applies; and in response to determining that the materials handling vehicle is approaching the temporal-based restriction zone at the first time the policy applies, sending, by the remotely located computing device, to the materials handling vehicle, data related to the policy, which causes the materials handling vehicle to adjust operation to comply with the policy when the materials handling vehicle enters the temporal-based restriction zone.

A ninety-first aspect includes the ninetieth aspect, further comprising, in response to determining that the materials handling vehicle is approaching the temporal-based restriction zone at a different time than the first time the policy applies, allowing the materials handling vehicle to enter the temporal-based restriction zone without interference.

A ninety-second aspect includes the ninetieth aspect and/or the ninety-first aspect, further comprising determining a second time that the policy applies.

A ninety-third aspect includes any of the ninetieth aspect through the ninety-second aspect, wherein the policy includes a first rule that applies to the first time and a second rule that applies to the second time.

A ninety-fourth aspect includes any of the ninetieth aspect through the ninety-third aspect, wherein the policy includes at least one of the following: a speed rule or a fork height rule.

A ninety-fifth aspect includes any of the ninetieth aspect through the ninety-fourth aspect, wherein the policy includes a time variable component that applies a first rule of the policy if the materials handling vehicle enters the temporal-based restriction zone during the first time, only if an other criteria is met.

A ninety-sixth aspect includes any of the ninetieth aspect through the ninety-fifth aspect, wherein the other criteria includes at least one of the following: a pedestrian congestion of a predefined area around the temporal-based restriction zone, a vehicle congestion of the predefined area around the temporal-based restriction zone, a condition of the materials handling vehicle, or a skill level of an operator of the materials handling vehicle.

A ninety-seventh aspect includes any of the ninetieth aspect through the ninety-sixth aspect, wherein the policy is specific to at least one of the following: a vehicle type, or the covered environment.

A ninety-eighth aspect includes a system comprising: a remotely located computing device that includes a processor and a memory component, the memory component storing logic that, when executed by the processor, causes the system to perform at least the following: create a temporal-based restriction zone for a covered environment, wherein the temporal-based restriction zone defines an area within which a materials handling vehicle must comply with a policy; define the policy; define a first time that the policy applies; determine a location and an orientation of the materials handling vehicle; determine, from the location and the orientation, that the materials handling vehicle is approaching the temporal-based restriction zone; determine whether a current time corresponds with the first time the policy applies; and in response to determining that the materials handling vehicle is approaching the temporal-based restriction zone at the first time the policy applies, send data related to the policy to the materials handling vehicle, which causes the materials handling vehicle to adjust operation to comply with the policy when the materials handling vehicle enters the temporal-based restriction zone.

A ninety-ninth aspect includes the ninety-eighth aspect, wherein in response to determining that the materials handling vehicle is approaching the temporal-based restriction zone at a different time than the first time the policy applies, the logic causes the system to allow the materials handling vehicle to enter the temporal-based restriction zone without interference.

A one hundredth aspect includes the ninety-eighth aspect and/or the ninety-ninth aspect, wherein the policy includes a time variable component that applies a first rule of the policy if the materials handling vehicle enters the temporal-based restriction zone during the first time, only if an other criteria is met, wherein the other criteria includes at least one of the following: a pedestrian congestion of a predefined area around the temporal-based restriction zone, a vehicle congestion of the predefined area around the temporal-based restriction zone, a condition of the materials handling vehicle, or a skill level of an operator of the materials handling vehicle.

A one hundred first aspect includes a system comprising: a remote computing device that includes a processor and a memory component, the memory component storing logic that, when executed by the processor, causes the system to perform at least the following: create a restriction zone policy for a plurality of covered environments, wherein the restriction zone policy defines a first rule with a restriction range on a hypothetical materials handling vehicle that is located in a restriction zone in at least one of the plurality of covered environments; create a first restriction zone for a first covered environment, wherein creating the first restriction zone includes defining a first location in the first covered environment of the first restriction zone; associate the restriction zone policy with the first restriction zone, wherein associating the restriction zone policy with the first restriction zone includes defining a first value within the restriction range for the first rule; and apply the restriction zone and the restriction zone policy to the location in the first covered environment.

A one hundred second aspect includes the one hundred first aspect, further comprising a materials handling vehicle in the first covered environment of the plurality of covered environments, wherein the materials handling vehicle includes a vehicle transceiver for determining a location of the materials handling vehicle in the first covered environment, a vehicle sensor for detecting an orientation of the materials handling vehicle and a vehicle computing device, wherein the logic further causes the system to perform at least the following: determine, from the vehicle transceiver and the vehicle sensor, that the materials handling vehicle is entering the restriction zone; and apply the first rule to restrict operation of the materials handling vehicle once the materials handling vehicle enters the restriction zone.

A one hundred third aspect includes any of the one hundred first aspect and/or the one hundred second aspect, wherein the logic is further configured to perform at least the following: create a second restriction zone for a second covered environment, wherein creating the second restriction zone includes defining a second location in the second covered environment of the second restriction zone; associate the restriction zone policy with the second restriction zone, wherein associating the restriction zone policy with the second restriction zone includes defining a second value within the restriction range for the first rule; and apply the second restriction zone and the restriction zone policy to the second location in the second covered environment.

A one hundred fourth aspect includes any of the one hundred first aspect through the one hundred third aspect, wherein creating the first restriction zone, associating the restriction zone policy with the first restriction zone, and applying the first restriction zone are initiated by a local administrator of the first covered environment.

A one hundred fifth aspect includes any of the one hundred first aspect through the one hundred fourth aspect, wherein creating the restriction zone policy is initiated by an enterprise administrator.

A one hundred sixth aspect includes any of the one hundred first aspect through the one hundred fifth aspect, wherein the logic further causes the system to receive an exception request to the restriction range for the first covered environment.

A one hundred seventh aspect includes any of the one hundred first aspect through the one hundred sixth aspect, wherein the logic further causes the system to perform least the following: receive a response to the exception request; determine whether the response to the exception request grants an exception; in response to determining that the response to the exception request grants the exception request, create a new restriction zone policy with the exception incorporated; and implement the new restriction zone policy in the first covered environment.

A one hundred eighth aspect includes any of the one hundred first aspect through the one hundred seventh aspect, wherein the first rule includes at least one of the following: a speed rule, a platform height rule, a fork height rule, or a vehicle specific rule.

A one hundred ninth aspect includes a method comprising: creating, by a remotely located computing device, a restriction zone policy for a plurality of covered environments, wherein the restriction zone policy defines a first rule with a restriction range on a hypothetical materials handling vehicle that is located in a restriction zone in at least one of the plurality of covered environments; creating, by the remotely located computing device, a first restriction zone for a first covered environment, wherein creating the first restriction zone includes defining a first location in the first covered environment of the first restriction zone; associating, by the remotely located computing device, the restriction zone policy with the first restriction zone, wherein associating the restriction zone policy with the first restriction zone includes defining a first value within the restriction range for the first rule; and applying, by the remotely located computing device, the restriction zone and the restriction zone policy to the location in the first covered environment.

A one hundred tenth aspect includes the one hundred eighth aspect, further comprising: determining, from a vehicle transceiver and a vehicle sensor of a materials handling vehicle, that the materials handling vehicle is entering the restriction zone; and applying the first rule to restrict operation of the materials handling vehicle once the materials handling vehicle enters the restriction zone.

A one hundred eleventh aspect includes the one hundred eighth aspect and/or the one hundred ninth aspect, further comprising: creating a second restriction zone for a second covered environment, wherein creating the second restriction zone includes defining a second location in the second covered environment of the second restriction zone; associating the restriction zone policy with the second restriction zone, wherein associating the restriction zone policy with the second restriction zone includes defining a second value within the restriction range for the first rule; and applying the second restriction zone and the restriction zone policy to the second location in the second covered environment.

A one hundred twelfth aspect includes any of the one hundred eighth aspect through the one hundred tenth aspect, wherein creating the first restriction zone, associating the restriction zone policy with the first restriction zone, and applying the first restriction zone are initiated by a local administrator of the first covered environment.

A one hundred thirteenth aspect includes any of the one hundred eighth aspect through the one hundred twelfth aspect, wherein creating the restriction zone policy is initiated by an enterprise administrator.

A one hundred fourteenth aspect includes any of the one hundred eighth aspect through the one hundred thirteenth aspect, further comprising receiving an exception request to the restriction range for the first covered environment.

A one hundred fifteenth aspect includes any of the one hundred eighth aspect through the one hundred fourteenth aspect, further comprising: receiving a response to the exception request; determining whether the response to the exception request grants an exception;

in response to determining that the response to the exception request grants the exception request, creating a new restriction zone policy with the exception incorporated; and implementing the new restriction zone policy in the first covered environment.

A one hundred sixteenth aspect includes any of the one hundred eighth aspect through the one hundred fifteenth aspect, wherein the first rule includes at least one of the following: a speed rule, a platform height rule, a fork height rule, or a vehicle specific rule.

A one hundred seventeenth aspect includes a system comprising: a remotely located computing device that includes a processor and a memory component, the memory component storing logic that, when executed by the processor, causes the system to perform at least the following: create a restriction zone policy for a plurality of covered environments, wherein the restriction zone policy defines a first rule with a restriction range on a hypothetical materials handling vehicle that is located in a restriction zone in at least one of the plurality of covered environments; create a first restriction zone for a first covered environment, wherein creating the first restriction zone includes defining a first dimension of the first restriction zone and a first location in the first covered environment of the first restriction zone; associate the restriction zone policy with the first restriction zone, wherein associating the restriction zone policy with the first restriction zone includes defining a first value within the restriction range for the first rule; and apply the restriction zone and the restriction zone policy to the location in the first covered environment.

A one hundred eighteenth aspect includes the one hundred seventeenth aspect, further comprising a materials handling vehicle in the first covered environment of the plurality of covered environments, wherein the materials handling vehicle includes a vehicle transceiver for determining a location of the materials handling vehicle in the first covered environment, a vehicle sensor for detecting an orientation of the materials handling vehicle and a vehicle computing device, wherein the logic further causes the system to perform at least the following: determine, from the vehicle transceiver and the vehicle sensor, that the materials handling vehicle is entering the restriction zone; apply the first rule to restrict operation of the materials handling vehicle once the materials handling vehicle enters the restriction zone; create a second restriction zone for a second covered environment, wherein creating the second restriction zone includes defining a second location in the second covered environment of the second restriction zone; associate the restriction zone policy with the second restriction zone, wherein associating the restriction zone policy with the second restriction zone includes defining a second value within the restriction range for the first rule; and apply the second restriction zone and the restriction zone policy with the second location in the second covered environment.

A one hundred nineteenth aspect includes the one hundred seventeenth aspect and/or the one hundred eighteenth aspect, wherein the logic further causes the system to perform at least the following: receive an exception request to the restriction range for the first covered environment; receive a response to the exception request; determine whether the response to the exception request grants the exception request; in response to determining that the response to the exception request grants an exception, create a new restriction zone policy with the exception incorporated; and implement the new restriction zone policy in the first covered environment.

A one hundred twentieth aspect includes any of the one hundred seventeenth aspect through the one hundred nineteenth aspect, wherein the first rule includes at least one of the following: a speed rule, a platform height rule, a fork height rule, or a vehicle specific rule.

Another aspect includes any of the previous aspects, wherein the vehicle sensor includes at least one of the following: a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a 4-dimensional LiDAR system, a RADAR system, a SONAR system, or a camera system.

Another aspect includes any of the previous aspects, wherein the vehicle location logic is located in at least one of the following: the covered environment or a computing device remote from the covered environment.

Another aspect includes any of the previous aspects, wherein the logic includes remote computing logic that is configured as telematics management software application with RTLS features for users to monitor, manage, and maintain the system, allow for administrators to monitor, configure, update, and maintain the RTLS system.

Another aspect includes any of the previous aspects, wherein the remote computing logic includes at least one of the following: an RTLS live map configured as a graphical environment map (such as a facility map, a racking map, a trailer map, etc.) showing icons for real time locations of active wireless devices on the network, a reporting module for providing API access to a user to generate its own reports and provide data as part of reports covering traffic and congestion, impacts and near-misses, and route playback, an enhancements module for providing options for users to enhance, define, and manage alerts, notifications, equipment, zones and user data associated with telematics services provided for the vehicle, and a commissioning tools module for setting up and managing the virtual representation of the covered environment and zones where the system should exercise control and awareness.

Another aspect includes any of the previous aspects, wherein the logic includes at least one of the following: vehicle location logic, which includes a system services module, a geolocation engine, or a policy enforcement module.

Another aspect includes any of the previous aspects, wherein the system services module is configured to monitor operation and health, setup, operate, and/or maintain the RTLS component, wherein the geolocation engine is configured for monitoring the location of the vehicles, and wherein the policy enforcement module is configured to arbitrate and apply policies to vehicles, store field shaping tables, and apply field shaping to the vehicles.

Another aspect includes any of the previous aspects, wherein the restriction zone includes at least one of the following shapes, rectangle, T-shaped, or square.

Another aspect includes any of the previous aspects, wherein the logic includes an enforcement module that is configured to arbitrate and apply policies to vehicles, wherein the policies enforced may include operational rules for multiple classes of interactions including at least one of the following: vehicle and vehicle, vehicle and pedestrian, or vehicle and restriction.

Another aspect includes any of the previous aspects, wherein the restriction zone is proximate to an acceleration line that signifies when the materials handing vehicle may resume normal operation.

Another aspect includes any of the previous aspects, wherein the restriction zone requires deceleration of the materials handling vehicle, wherein declaration requires a deceleration determination, wherein the deceleration determination may be based on at least one of the following: standard vehicle deceleration, current payload, current tire wear, floor friction, recent decelerations, current speed, or ending speed.

Another aspect includes any of the previous aspects, further comprising providing a user interface that includes at least one of the following: an add site policy option, an add enterprise policy option, a combine zones option, a dimensions option, an add option, and a location option, a define zones section, or an edit zones option.

Another aspect includes any of the previous aspects, wherein the temporal-based rule is applied with another temporal-based rule.

Another aspect includes any of the previous aspects, wherein the temporal-based rule is applied with a rule that is not-temporal based.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A depicts a cloud-based computing environment determining a restriction zone, according to embodiments provided herein;

FIG. 1B depicts an environment-based computing environment for determining a restriction zone, according to embodiments provided herein;

FIG. 2 depicts computing infrastructure associated with the remote computing logic and the vehicle location logic from FIGS. 1A and 1B, according to embodiments provided herein;

FIG. 3 depicts a vehicle traversing a route in a covered environment, according to embodiments provided herein;

FIGS. 4A, 4B depict a vehicle preparing to comply with a policy of a restriction zone, according to embodiments provided herein;

FIG. 5A depicts a user interface for defining zone policies, according to embodiments provided herein;

FIG. 5B depicts a user interface for providing temporal zone policies, according to embodiments provided herein;

FIG. 5C depicts a user interface for adding zone policies and rules, according to embodiments provided herein;

FIG. 5D depicts a user interface for providing global policies and zone-based policies, according to embodiments provided herein;

FIG. 6 depicts a flowchart for performing a zone look ahead, according to embodiments provided herein;

FIG. 7 depicts a flowchart for assigning entry edges to a restriction zone, according to embodiments provided herein;

FIG. 8 depicts a flowchart for providing restriction zone controls, according to embodiments provided herein;

FIG. 9 depicts a flowchart for providing zones across a plurality of sites, according to embodiments provided herein;

FIG. 10 depicts a flowchart for providing temporal zone policies, according to embodiments provided herein;

FIG. 11 depicts a flowchart for providing range-based enterprise zones, according to embodiments provided herein; and

FIG. 12 depicts the remote computing device of FIGS. 1A, 1B, according to embodiments provided herein.

### DETAILED DESCRIPTION

Embodiments disclosed herein include systems and methods for providing a restriction zone in a covered environment. These embodiments may be configured to affect operation of a materials handling vehicle that enters the restriction zone. Some embodiments may be configured to utilize location data, as well as vehicle data to accurately prepare the materials handling vehicle to comply with rules of an upcoming restriction zone at an entry edge of the restriction zone. Some embodiments may define one or more restrictions to a vehicle (or type of vehicle) that enters the restriction zone in a single user interface. Some embodiments may be configured to assign different restrictions, based on whether the materials handling vehicle enters the restriction zone from different edges and/or locations. Some embodiments may be configured to define enterprise wide rules and/or policies to zone types, as well as localized rules and/or policies. Some embodiments may be configured to define temporal-based rules and/or policies to restriction zones. Still some embodiments may be configured to provide zone rules and/or policies based on ranges of acceptable vehicle behavior.

As such, these embodiments may determine a location of a vehicle in the covered environment. A covered environment may include a warehouse environment, a manufacturing environment, a retail environment, an industrial environment, a distribution environment, a commercial environment, or other area that includes a plurality of anchors and tags, where the location technology is configured to track the location and pose of the tags within a geographical area covered by the anchors. Some embodiments utilize an ultra-wide band (UWB) location technology with a single transceiver on a vehicle that may be utilized for locating the vehicle in a covered environment. A single vehicle-mounted UWB transceiver communicates to a plurality of UWB transceiver anchors with static, known locations that can then locate the vehicle(s) using a time of flight differential methodology (such as time of flight trilateration, point to point, two way ranging, etc.), which determines the position of the vehicle based on its distance to each of the plurality of transceiver anchors placed on respective stationary objects with whom the vehicle is actively communicating. UWB anchors may be communicatively coupled to a remote computing device and/or local computing device to perform this function. UWB tags may be placed on mobile objects, such as pedestrians, pallets, etc. and may not be communicatively coupled to a remote computing device and/or local computing device.

Embodiments may also include one or more vehicle sensors (such as a first sensor and/or a second sensor) for determining a direction of motion, meaning whether the vehicle is traveling forward or backward and/or for determining a steer angle of a steering wheel of the vehicle. This sensor data may be utilized to calculate an orientation of the vehicle and/or a vector of movement of the vehicle. The vehicle sensors may include a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a 4-dimensional LiDAR system, a RADAR system, a SONAR system, or a camera system. These embodiments may be configured to join sensor data together via sensor fusion to enable vector tracking of the vehicle. Vector tracking enabled by sensor fusion can then be applied to create a shaped detection field that will have less impact to productivity.

Accordingly, embodiments for zone look-ahead may include determining that the vehicle is headed toward a restriction zone. These embodiments may determine a rule and/or policy associated with the restriction zone. These embodiments may determine an adjustment to the current operation of the vehicle to comply with the rules and/or policy by the time the vehicle reaches an edge of the restriction zone. As an example, if the vehicle is currently traveling 5 MPH and the restriction zone mandates a 1 MPH speed, these embodiments would determine that the vehicle needs to reduce its speed by 4 MPH before reaching the entry edge of the restriction zone. These embodiments may additionally determine the time and/or distance it will take for the vehicle to make the required adjustment. This determination may be based on vehicle standards, payload, etc. In this example, this determination would be to determine how long (distance and/or time) it would take to reduce the vehicle speed from 4 MPH to 1 MPH. These embodiments would then determine an adjustment line by which to begin decelerating, such that the vehicle reaches 1 MPH before reaching the entry edge of the restriction zone. This improves efficiency, as the vehicle may maintain desired speed until necessary to begin making adjustments to current operations.

Similarly, embodiments of dynamic entry edges includes providing a platform to assign different rules and/or policies to a vehicle, based on the entry edge the vehicle uses to enter the restriction zone. As an example, if a restriction zone is located at an end of aisle area, the restriction zone may be configured as a rectangle, a square, and/or in a “T” shape. Depending on the embodiment, the “T” shaped restriction zone may be created by combining two or more rectangular restriction zones and/or providing a free-hand approach to creation of a restriction zone. Regardless, vehicles that are merely passing through the zone, but not exiting the aisle may be restricted to 3 MPH, while vehicles that enter the restriction zone from the aisle may be restricted to 1 MPH. Again, this improves efficiency of the vehicles by not requiring unnecessary slowdowns.

Embodiments for providing zone controls may include embodiments that provide a user interface that allows an administrator to assign a plurality of rules to a restriction zone policy. As an example, it may be desirable that a restriction zone treat different vehicle types differently. In some embodiments, it may be desirable for a restriction zone have a dynamic component, such as providing a restriction of a maximum speed when a fork is raised. As such, embodiments provide an administrator with a simple mechanism for configuring a plurality of rules applied to a restriction zone.

Embodiments for applying policies and/or rules across different environments may also be provided. In these embodiments, enterprise administrators may be provided with access to create policies that environment administrators may use for their particular environment. As an example, if Acme Company has ten locations under the same management, Acme may desire that all pedestrian-based restriction zones have a speed limit of 1 MPH. As such, embodiments may provide options for creating an enterprise-wide policy, such that when a local administrator creates a zone in a pedestrian area, the system automatically adopt the enterprise wide policy to the created zone.

Similarly, some embodiments may be configured to create enterprise-wide polices with ranges. In these embodiments, the enterprise administrator may not dictate the exact rule placed on the environment, but instead provide a range, a maximum, and/or a minimum for the environment to comply. In such an embodiment, the environment administrator may select the rule that is within the range. As an example, different high traffic areas in different covered environments may have different characteristics, including different volume of traffic, different space restrictions, different vehicles, etc. As such, an enterprise administrator may decide that the environment administrator is better equipped to determine the actual rule for a high traffic area, but puts a range of 2 MPH to 5 MPH as a maximum. Thus, any environment administrator may select a required speed or speed limit within that range.

Embodiments of temporal based restriction zones may similarly allow an administrator to vary the rules and/or policies placed on a restriction zone, based on time of day, day of week, etc. These embodiments may thus allow for dynamic rules that change, based on the conditions of an environment. These embodiments improve efficiency by requiring slowdowns only during particular times of the day.

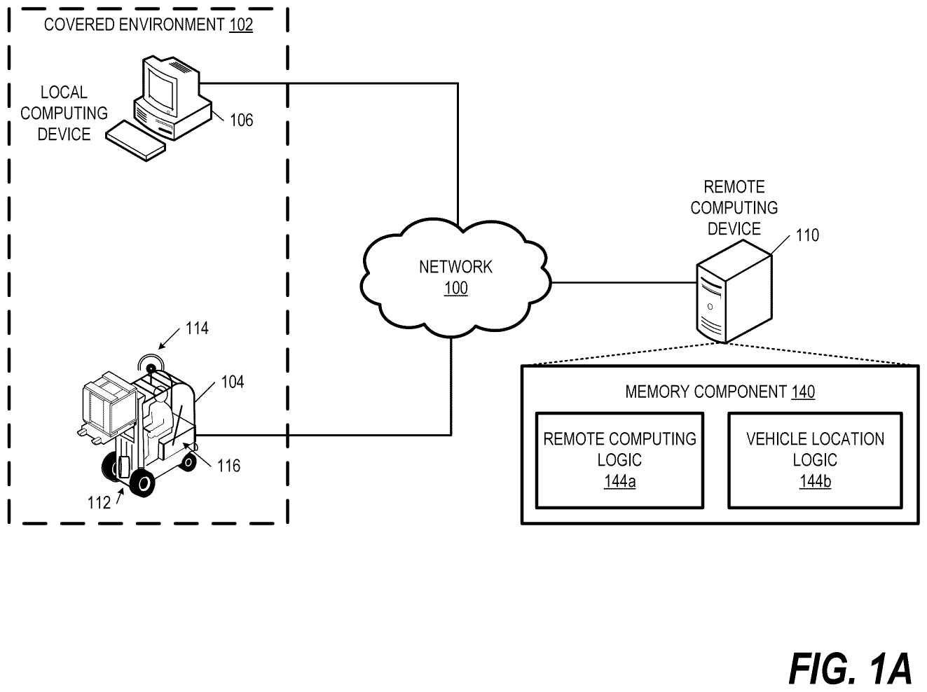

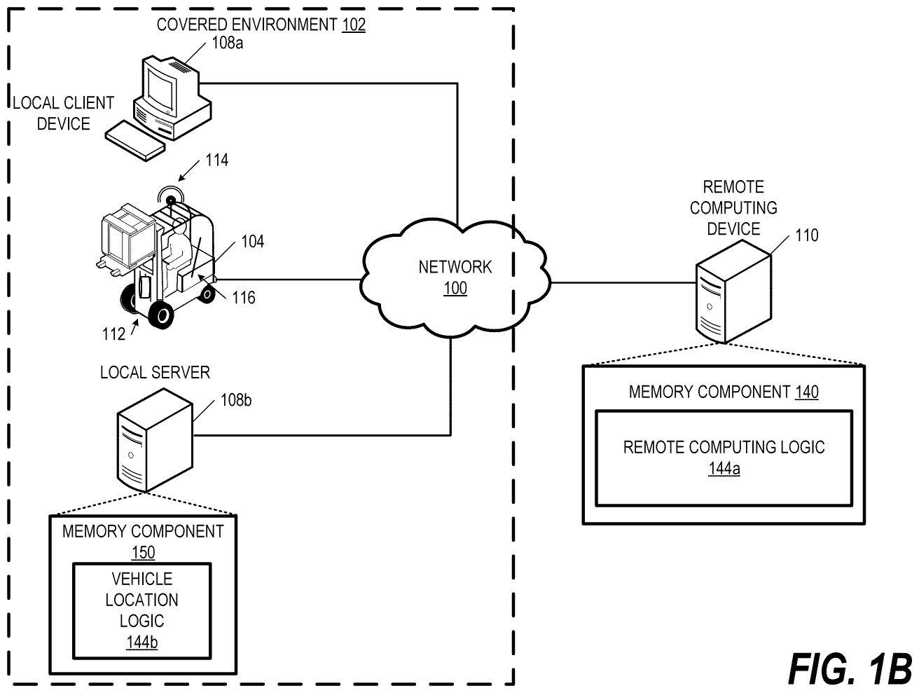

Referring now to the drawings, FIG. 1A depicts a cloud-based computing environment for determining a restriction zone, according to embodiments provided herein. As illustrated, the computing environment may include a network 100 coupled to components in a covered environment 102, such as a vehicle 104 and a local computing device 106. Also coupled to the network 100 is a remote computing device 110.

The vehicle 104 may be configured as a materials handling vehicle or other vehicle that is configured to traverse an industrial area, such as the covered environment 102 that includes objects, as described herein. In the context of the present disclosure, it is noted that a “materials handling vehicle” comprises a vehicle primarily designed for towing or lifting and moving a payload such as, for example, a warehouse tugger, a forklift vehicle, a reach vehicle, a turret vehicle, a walkie stacker vehicle, a tow tractor, a pallet vehicle, a high/low, a stacker-vehicle, trailer loader, a sideloader, a fork hoist, or the like.

The vehicle 104 may include at least one vehicle sensor 112, which may include a steering wheel sensor for detecting a steer angle, a wheel speed sensor for determining a speed of the vehicle 104 and/or for determining a direction of motion, such as whether the vehicle 104 is moving forward or backward, an odometer, an onboard inertial measurement unit (IMU), such as with an accelerometer and/or a gyroscope, and a proximity detection device (or more than one) for detecting objects in the proximity of the vehicle 104. Depending on the particular embodiment, the vehicle sensor 112 may be configured as a 2-dimensional LiDAR system, a 3-dimensional LiDAR system, a RADAR system, a SONAR system, a camera system, and/or other device or system that can detect the presence of objects in the proximity of the vehicle 104. In some embodiments, the vehicle 104 includes only one vehicle sensor 112, while some embodiments are configured such that a plurality of vehicle sensors 112 are coupled to the vehicle 104 and provide a wide angle (e.g. 180 degree, 270 degree, 360 degree) view of objects around the vehicle 104.

It should be understood that each of the LiDAR devices may be a LiDAR scanner capable of detecting objects in a field of view of the LiDAR scanner, such as, for example, the SICK TiM781, the SICK microScan3, or the IDEC SE2L. The remote computing device 110 may receive signals from the LiDAR device indicative of the detected object. The LiDAR devices may be mounted in various locations on the vehicle 104 to detect objects around the vehicle 104, such as, for example, a front, a rear, a top, a side, or the like.

In some embodiments, the vehicle 104 may include a first LiDAR device mounted on a first side (e.g., front) of the vehicle 104 and a second LiDAR device mounted on a second side (e.g., back) of the vehicle 104 that is opposite the first side. The first LiDAR device may detect objects in the direction of the first side of the vehicle 104 such as when the vehicle 104 is moving in a forward direction. The second LiDAR device may detect objects in the direction of the second side of the vehicle 104 such as when the vehicle 104 is moving in a rearward direction. The vehicle 104 may include an operator compartment and a pair of forks for picking cargo within the covered environment 102 where the operator compartment and/or lift may be raised and lowered to pick cargo from shelves that are above the vehicle 104. The second LiDAR device may be mounted on a portion of the vehicle 104 separate from the operator compartment and forks that is not raised and lowered such that the second LiDAR device is disposed at a static distance away from the ground. When the operator compartment is lowered, the operator compartment may obstruct the view of the second LiDAR device. The vehicle 104 may be configured to raise the operator compartment to a predetermined height above the second LiDAR device when the vehicle 104 is moving in the rearward direction so that the operator compartment does not obstruct the view of the second LiDAR device.

Similarly, while some embodiments are configured to detect objects in proximity of the vehicle 104 via the vehicle sensor 112, some embodiments may be configured to acquire the environment data and construct a virtual representation of an area of the environment around the vehicle 104 from which the object is detected. As discussed in more detail below, these embodiments may utilize the vehicle sensor 112 and/or a vehicle transceiver 114.

As such, embodiments may be configured to receive sensor data related to a direction of motion of the vehicle 104 (e.g., whether the vehicle 104 is moving forward or backward, whether the lift is moving upward or downward, etc.), a steer angle of the vehicle 104, and/or other sensor data to determine an orientation of the vehicle 104. More specifically, if the covered environment 102 utilizes a UWB system, these embodiments may be configured to determine a location of the vehicle 104. This UWB location data may be delayed from real-time and thus may not represent the most current location of the vehicle 104. In these embodiments, vehicle sensors 112 indicate that the vehicle 104 is driving forward and the steering wheel is turned right 20 degrees (e.g., the steer angle).

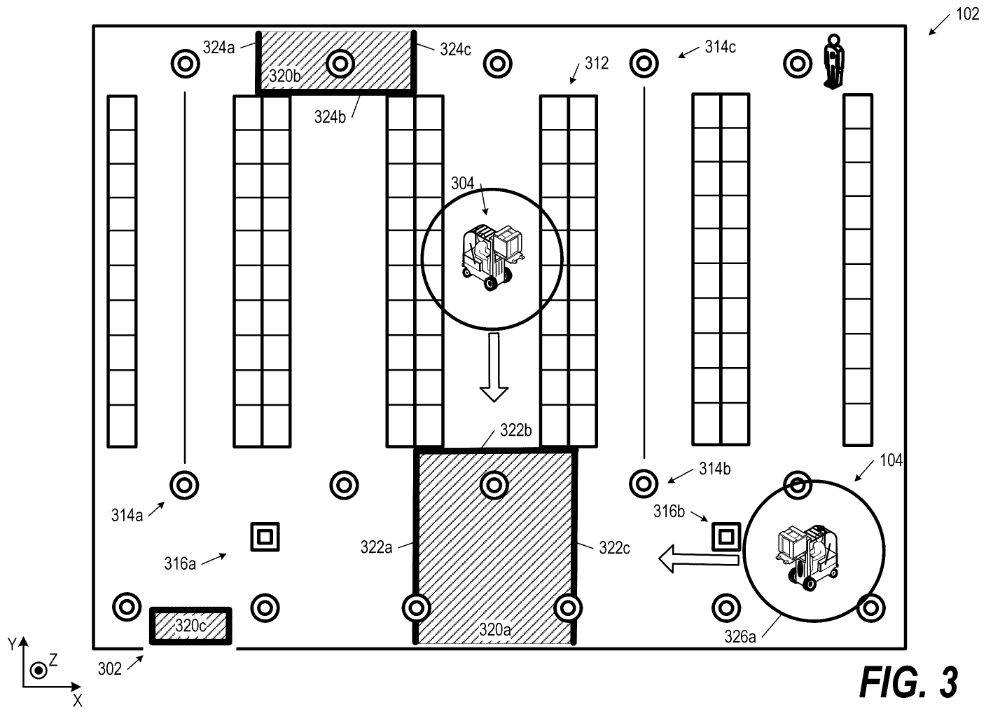

The vehicle 104 may also include the vehicle transceiver 114 for communicating with a wireless transceiver 314 and/or 316 (FIG. 3) and/or with the remote computing device 110. As described in more detail below, some embodiments may be configured such that the covered environment 102 has a plurality of wireless transceivers 314, 316 positioned at known fixed locations and broadcast a signal that includes an identifier of that wireless transceiver 214. A vehicle computing device 116 on the vehicle 104 may include a vehicle memory component, vehicle processor, and/or other computing components, as described with reference to the local server 108b and/or the remote computing device 110. The vehicle computing device 116 and/or the remote computing device 110 may determine a current location of the vehicle 104 from the received wireless communication. Similarly, one or more wireless transceivers 214 may be positioned on moving objects in the covered environment 102. In these embodiments, the location of the wireless transceivers 214 may be determined and compared with the determined position of the vehicle 104.

The vehicle 104 may include a display (not explicitly shown) to provide one or more user interfaces. The vehicle 104 may include a proximity control module (PCM) as part of the vehicle computing device 116 that communicates with vehicle sensors 112, such as an accelerometer, a gyroscope, the vehicle transceiver 114, etc. (which may be embodied as a radio antenna module (RAM), etc.), to arbitrate received data and provide command alerts and slowdowns to the vehicle 104 and equipped system components. The vehicle transceiver 114 may be configured as a UWB transceiver that receives UWB network data and transmits vehicle data. The vehicle transceiver 114 may be connected to the PCM for power and two-way communication. The vehicle 104 may include a user option to calibrate and/or recalibrate a vehicle orientation.

Also included in FIG. 1A is the remote computing device 110. The remote computing device 110 may be configured as a personal computer, laptop, server, tablet, mobile device, vehicle computing device 116, and/or other computing device that includes the hardware and provides the functionality described herein. It should also be noted that some embodiments may be configured such that at least a portion of the computing described with reference to the remote computing device 110 is embodied in the vehicle computing device 116 that is integrated onto the vehicle 104 and/or otherwise provided locally from the covered environment 102.

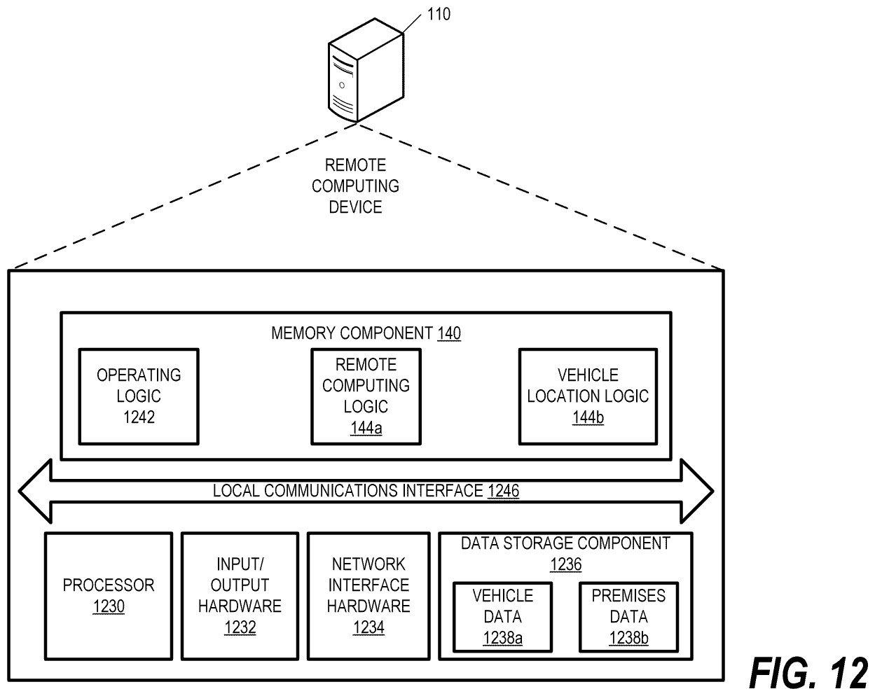

Regardless, the remote computing device 110 may include a plurality of components (described in more detail with reference to FIG. 12), such as a memory component 140. The memory component 140 may be configured as read access memory (RAM), read-only memory (ROM), registers, etc. The memory component 140 may be configured to store logic or other computer-readable instructions, such as remote computing logic 144a and vehicle location logic 144b. The remote computing logic 144a may include instructions for providing user interfaces to allow a user to define zones, as well as illustrate the covered environment 102. As an example, the remote computing logic 144a may provide user interfaces, discussed in more detail below. The vehicle location logic 144b may be part of a real time location tracking system (RTLS) that be configured to communicate with one or more transceiver anchors, wire guide systems, odometry systems, and/or other extra-vehicle systems to determine a real time location of the vehicle 104, as described in more detail below.

The local computing device 106 may be configured as a local bridge, a desktop computer, laptop, tablet, mobile device, server, etc. In some embodiments, the local computing device 106 may be configured to provide administrative viewing and controls of the vehicle 104 and/or remote computing device 110. Specifically, some embodiments are configured such that the local computing device 106 may be configured for defining one or more restriction zones 320, policies, and/or rules, as provided herein. Some embodiments may utilize the remote computing device 110 (embodied as a personal computer or other computing device with a user interface) for performing this function.

Specifically, embodiments described herein may provide one or more user options with the ability to define restriction zones 320 for a particular environment and/or provide an administrator portal for a local administrator to select previously defined policies and determine the location and size of restriction zones 320 for a particular covered environment 102. Some embodiments may be configured such that an enterprise administrator (e.g., utilizing the remote computing device 110) may define enterprise-wide policies and/or rules for local administrators to utilize. As such, some embodiments may include a plurality of covered environments 102 with respective first local computing device, second local computing device, etc. with respective local memory component, local processor, etc. for serving the respective covered environments.

Accordingly, embodiments provided herein may refer to a remotely located computing device, which identifies a computing device that is located remote from the vehicle 104. The remotely located computing device may include the local computing device 106, the local client device 108a, the local server 108b, the remote computing device 110 and/or other computing device that may or may not be located in the covered environment 102. Other administrative controls may also be provided. As such, it should be noted that as described herein, the phrase “local computing device” may refer to the local computing device 106, the local client device 108a and/or the local server 108b described in FIG. 1B.

FIG. 1B depicts an environment-based computing environment for utilizing restrictive zones, according to embodiments provided herein. As illustrated, the computing environment may include the network 100 coupled to components in the covered environment 102, such as a vehicle 104, a local client device 108a, a remote computing device 110, as described with reference to FIG. 1A. However, FIG. 1B depicts a local server 108b, which may be configured with a memory component 150 storing the vehicle location logic 144b.

The local server 108b, may be configured as a local bridge, desktop computer, laptop, tablet, mobile device, server, etc. In some embodiments, the local server 108b may be configured to provide administrative viewing and controls of the vehicle 104 and/or remote computing device 110. Other administrative controls may also be provided. The local server 108b may include a memory component 150. The memory component 150 may store the vehicle location logic 144b may be configured to determine a location of the vehicle 104 within a covered environment 102 using one or more of a plurality of different technologies, such as UWB, wireless fidelity (Wi-Fi), wire guidance, cellular, etc. Thus, while the vehicle location logic 144b may be functionally similar to the vehicle location logic 144b from FIG. 1A, in FIG. 1B, the local server 108b may operate within or proximate the covered environment 102. As described above, a remotely located computing device may refer to the components of FIG. 1B and/or FIG. 1A.

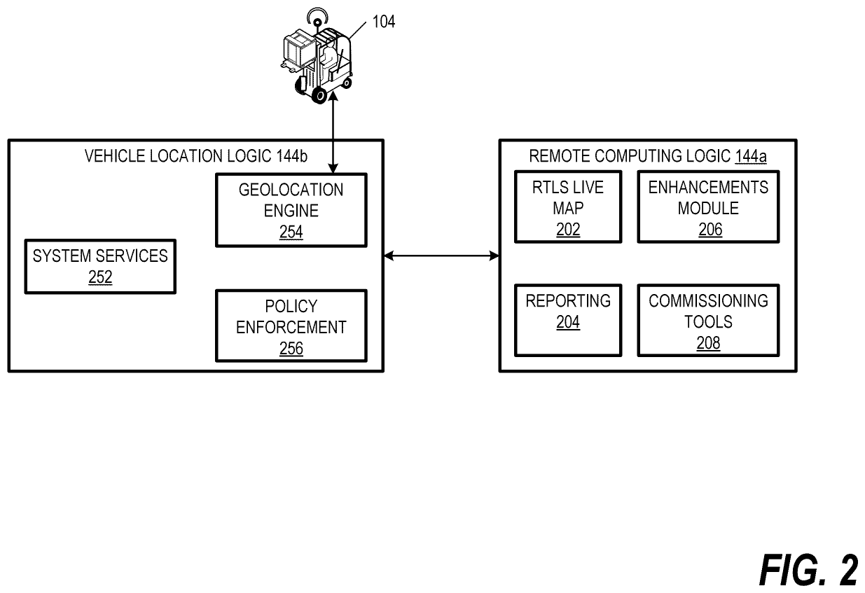

FIG. 2 depicts computing infrastructure associated with the remote computing logic 144a and the vehicle location logic 144b from FIGS. 1A and 1B, according to embodiments provided herein. As illustrated, the remote computing logic 144a may be configured as telematics software application with RTLS features for users to monitor, manage, and maintain the system. As such, the remote computing logic 144a may be configured as an interface to the RTLS system. The remote computing logic 144a may be configured to allow for administrators to monitor, configure, update, and maintain the RTLS system. Additionally, those with lower rights are provided options to view RTLS data and report on the RTLS data. The remote computing logic 144a may include one or more modules, which may be implemented in hardware, software, and/or firmware. As illustrated, the remote computing logic 144a may include an RTLS live map 202, a reporting module 204, an enhancements module 206, a commissioning tools module 208. The RTLS live map 202 may be configured as a graphical map of the covered environment 102 (and/or other environment) showing icons for real time locations of all active UWB devices on the network 100 (representing vehicles, pedestrians, and potentially materials and/or other equipment) as well as tools to dive deeper into current and/or historical information regarding environment, vehicle, operator, tag, wearable device, and/or user. The RTLS live map 202 communicates with other components on the network 100.

The reporting module 204 may provide API access to a user to generate custom reports as well as provide additional data as part of existing reports. In some embodiments, reporting module 204 may contain enhanced and/or additional built-in reports covering topics such as traffic and congestion, impacts and near-misses, route playback, etc. As such, the reporting module 204 may include an API module, a reports module, a heat maps module, a route playback module, and/or other modules for providing the functionality described herein.

The enhancements module 206 may provide options for users to enhance and/or manage alerts, notifications, equipment, user data, etc. associated with telematics services provided for the vehicle 104. This management of existing telematics systems may be configured to permit the RTLS system to work with the features provided herein.

The commissioning tools module 208 may include tools to setup and manage the virtual representation of the environment and restriction zones 320 where the system should exercise control and/or awareness to UWB transceiver anchors. Additionally, the commissioning tools module 208 may be configured to provide tools to setup and manage the hardware and/or software on the downstream system components such as the server, anchors, etc. These tools communicate to the other systems. Further, the commissioning tools module 208 may be configured to provide options and/or interfaces for a user to define zones, design policies and/or design rules associated with restriction zones, as well as implement the restriction zones, policies, and rules.

The vehicle location logic 144b may include tracking and control logic to enable low latency, high accuracy vehicle tracking, vehicle reactions, and operator/user alerts. When implemented as hardware on-site (e.g., FIG. 1B), the vehicle location logic 144b may be configured as a physical server at the covered environment 102 dedicated to RTLS tasks. When implemented in the cloud (e.g., FIG. 1A), the vehicle location logic 144b may be configured as a virtual server in a cloud hosted data center off-site using third party machine computer capacity. The vehicle location logic 144b may be communicatively coupled to the wireless transceivers 314 (FIG. 3), which may be configured as UWB anchors which send/receive data wirelessly with the tag devices on the network. This data is then processed and distributed to the appropriate destination to the tag devices and/or through traditional networking to the components in the cloud.

As illustrated, the vehicle location logic 144b may include a system services module 252, a geolocation engine 254, and a policy enforcement module 256. The system services module 252 may be configured to monitor operation and/or health of RTLS components, which include hardware and/or software on the vehicle 104 that provide location tracking of the vehicle 104. The system services module 252 may additionally be configured to setup, operate, and/or maintain the RTLS components. The system services module 252 may offer communication to and/or from the other system components such as the remote computing logic 144a and the vehicle 104, the vehicle 304, other vehicles, and/or pedestrians.

The geolocation engine 254 may be configured to manage UWB communications for the network 100, including high precision time syncing and location tracking. The geolocation engine 254 may include custom implementations of UWB software technologies to be employed for the RTLS features. Specifically, the geolocation engine 254 may be configured to utilize logical components for monitoring the location of the vehicles 104, 304, as well as send commands to the vehicles 104, 304.

The policy enforcement module 256 may be configured to arbitrate and apply policies to vehicles 104, 304. Policies enforced may include operational rules for multiple classes of interactions including: vehicle 104 and vehicle 304, vehicle 104 and pedestrian, vehicle 104 and restriction zone 320 (FIG. 3). Restriction zones 320 may be two pronged: first, the virtual representation of the area where a rule and/or policy should be applied/enforced; and second, may define the policies/rules to be applied. As an example, end of aisle, pedestrian crossing, disallowed area, etc. with custom rules applied to vehicles 104 and/or pedestrians that result in slowdown of the vehicle 104 and/or alerts. Policy enforcement module 256 may include sensor fusion technology and may communicate directly with the geolocation engine 254 to initiate the vehicle and pedestrian reactions in a timely manner. The policy enforcement module 256 may additionally store any field shaping tables and apply field shaping to the vehicles 104, 304, as described herein.

FIG. 3 depicts a vehicle 104 traversing a route in a covered environment 102, according to embodiments provided herein. As illustrated, the covered environment 102 may encompass any indoor or outdoor industrial facility in which materials handling vehicles transport goods including, but not limited to, indoor or outdoor industrial environments that are intended primarily for the storage of goods, such as those where multi-level racks are arranged in aisles, and environments where goods are transported about the environment by vehicles 104 for use in one or more manufacturing processes. The covered environment 102 may include a plurality of objects, such as racking 312 that define one or more aisles for the vehicle 104 to traverse. The covered environment 102 may additionally include a plurality of wireless transceivers 314, 316 (e.g. wireless transceiver 314a, wireless transceiver 314b, wireless transceiver 314c, wireless transceiver 316a, and/or wireless transceiver 316b).

The wireless transceivers 314 may be configured as UWB transmitters, while the wireless transceivers 316 may be configured as wireless fidelity (Wi-Fi) transmitters or other wireless protocol transmitters. As the wireless transceivers 314, 316 are located at fixed locations as a transceiver anchor (and/or coupled to a fixed object), the vehicle 104 may utilize data received from the wireless transceivers 314 and/or 316 to determine a location of the vehicle 104 in the covered environment 102. As such, the vehicle 104 may utilize the communication data to center the vehicle 104 in an aisle, as well as determine where in the covered environment 102 the vehicle 104 is located in order to traverse a route within the covered environment 102.

Additionally, the covered environment 102 may include at least one restriction zone 320, such as a high traffic area 320a, an end of aisle area 320b, and a default zone 320c. The high traffic area 320a may be identified as an area with a high traffic volume and thus may require the vehicle 104 to reduce maximum speed while located in the high traffic area 320a. The high traffic area 320a may include edges 322a, 322b, 322c, which may provide triggers for entering and/or leaving the high traffic area 320a. The end of aisle area 320b may be configured similar to the high traffic area 320a, except that the end of aisle area 320b may cause the vehicle 104 to reduce speed due to a turn that the vehicle 104 must take. The end of aisle area 320b may include edges 324a, 234b, 324c which may provide triggers for entering and/or leaving the end of aisle area 320b. The default zone 320c may be configured such that upon crossing a predetermined edge of the default zone 320c, a default characteristic (or characteristics) is applied for the vehicle. As an example, if the vehicle 104 enters the covered environment 102 via a doorway 302, the vehicle 104 may necessarily cross an interior edge of the default zone 320c. By doing so, a restriction of a maximum speed of 5 MPH may be imposed on the vehicle 104 until the vehicle 104 leaves the covered environment 102 by crossing an exterior edge of the default zone 320c, at which time this restriction may be removed. If, while in the covered environment 102, the vehicle 104 encounters the high traffic area 320a and/or end of aisle area 320b, those restriction zones may further limit operations the vehicle 104.

Similarly, covered environments 102 often have a rule that the vehicle 104 must come to a stop at the end of an aisle. If the operator does not come to a stop, the system may cause the vehicle 104 to slow down so that it is not traveling at full speed out of the aisle. As such, the high traffic area 320a and/or the end of aisle area 320b may be user-defined areas with user-defined rules that are marked by a user and/or automatically identified and marked by the remote computing device 110.

The vehicle 104 may additionally encounter a second vehicle 304. The second vehicle 304 may include a wireless transceiver 214 that may be utilized to determine its own location via the wireless transceivers 314, 316. The vehicle 304 may additionally have one or more vehicle sensors 112 for detecting operational characteristics of the vehicle 304.

It should be noted that the wireless transceivers 314, 316 may be configured as transmitters and/or receivers. As such, the wireless transceivers 314, 316 may include one or more hardware, software, and power to facilitate that functionality. Similarly, the vehicle transceiver 114 may be configured as a receiver and/or a transmitter, depending on the particular embodiment.

It will also be understood that some embodiments may include any of a high traffic area, a pedestrian area, a truck-specific area, or an end of aisle area. These areas may be configured to restrict the vehicle 104 according to different criteria. As an example, a truck-specific area may apply different policies and/or rules, based on the type of truck that enters.

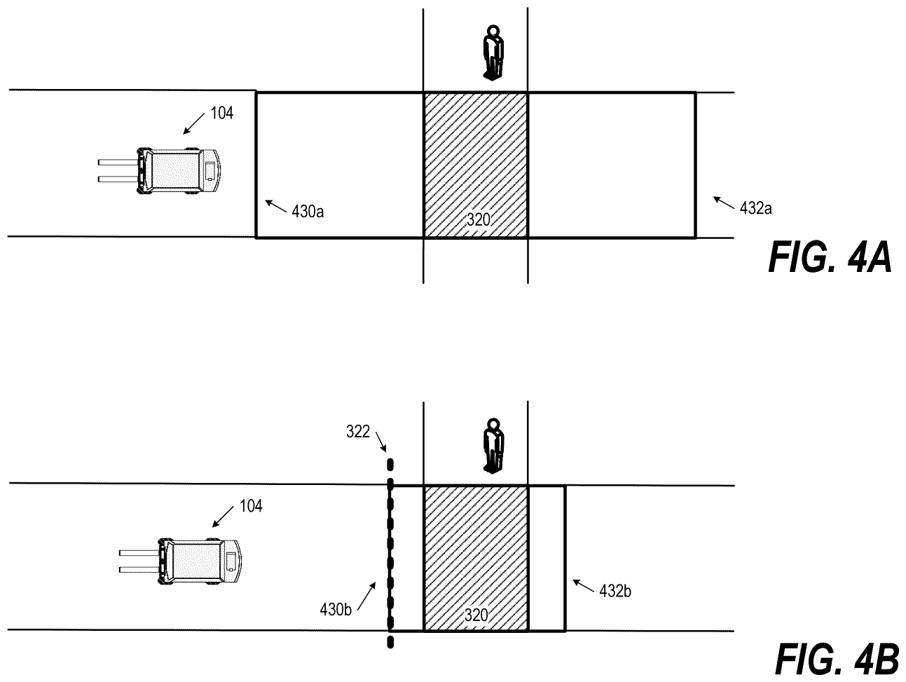

FIGS. 4A, 4B depict a vehicle 104 preparing to comply with a policy of a restriction zone 320, according to embodiments provided herein. As illustrated in FIG. 4A, a vehicle 104 may be approaching a restriction zone 320, which may be configured as a pedestrian area, such as a pedestrian walkway. As such, FIG. 4A depicts contemporary solutions that detect the restriction zone 320. In these solutions, the vehicle 104 is configured to automatically adjust operation at the deceleration line 430a, which is a static line for all vehicles 104 and represents a catch-all perimeter. Specifically, the deceleration line 430a triggers all vehicles in the covered environment 102 to begin adjusting operation to comply with the rules of the restriction zone 320. This ensures that all vehicles meet the rules by the time the vehicle reaches the restriction zone 320. As is evident, because the example of FIG. 4A utilizes a one-size-fits-all configuration, the vehicle 104 may be required to alter operation well before necessary to comply with the rules of the restriction zone 320. Additionally, once the vehicle 104 exits the restriction zone 320, an acceleration line 432a represents a line where the vehicle 104 may begin resuming normal operation.

FIG. 4B depicts an embodiment provided herein regarding advanced preparation for entering the restriction zone 320. Specifically, as the vehicle 104 is approaching the restriction zone 320, the vehicle location logic 144b may be configured to cause a remotely located computing device to determine the location and orientation of the vehicle 104 to determine that the vehicle 104 is actually expected to enter the restriction zone 320. Accordingly, the remotely located computing device may send the vehicle 104 the rules associated with the restriction zone 320, as well as a distance (e.g., a first distance) from the restriction zone 320 that the vehicle 104 is. With this information, the vehicle 104 determines the vehicle-specific adjustments that are required to adjust current vehicle operation to comply with the rule of the restriction zone 320.

As an example, once a determination is made that the vehicle 104 is going to encounter the restriction zone 320, a rule of the restriction zone 320 and a location of the vehicle 104 are sent to the vehicle 104. If the rule is that the vehicle 104 must travel at a speed of 1 MPH while in the restriction zone 320, the vehicle 104 determines its current speed and deceleration rate. The vehicle 104 additionally computes where the vehicle 104 will need to begin decelerating in order to reach the required 1 MPH at the entrance to the restriction zone 320, which is represented with the vehicle-specific line 322. This deceleration determination (and thus the location of the vehicle-specific line 322) may be based on standard vehicle deceleration, current payload, current tire wear, floor friction, recent decelerations, current speed, ending speed, and/or other information. As such, the deceleration line 430b corresponds with the vehicle-specific line 322 in FIG. 4B because the vehicle 104 will start decelerating when the vehicle 104 needs to start decelerating to comply with the rule by the time the vehicle 104 reaches an entry edge of the restriction zone 320. Similarly, the acceleration line 432b may be customized for the vehicle 104, based on the current speed, desired speed, acceleration rate, etc. and/or may be a single line for all vehicles. The acceleration rate may be dependent upon similar factors as used for the deceleration rate.

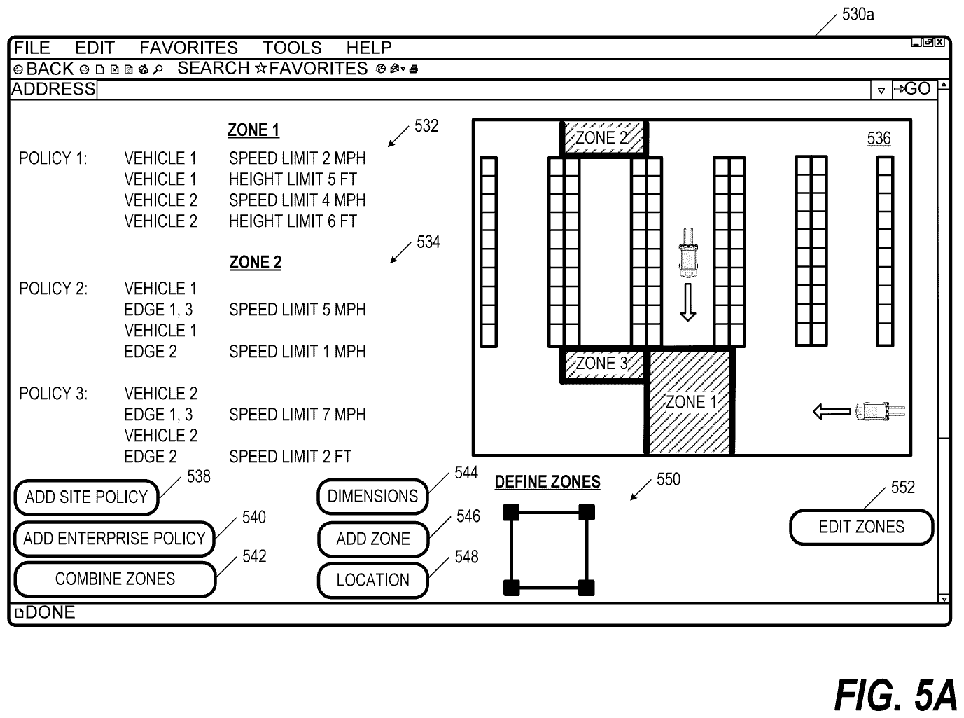

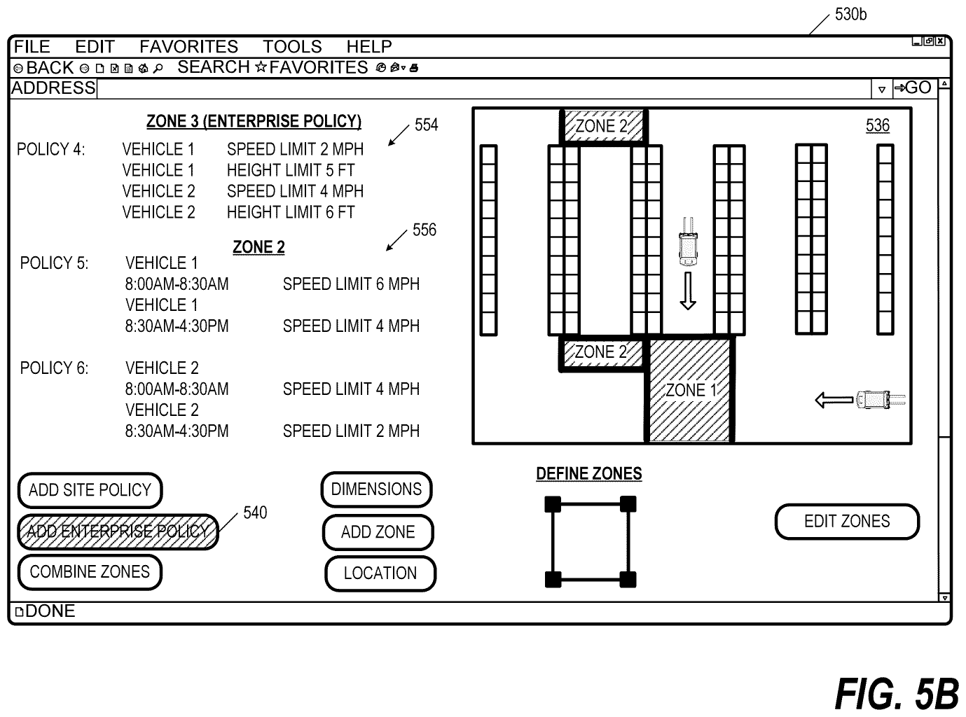

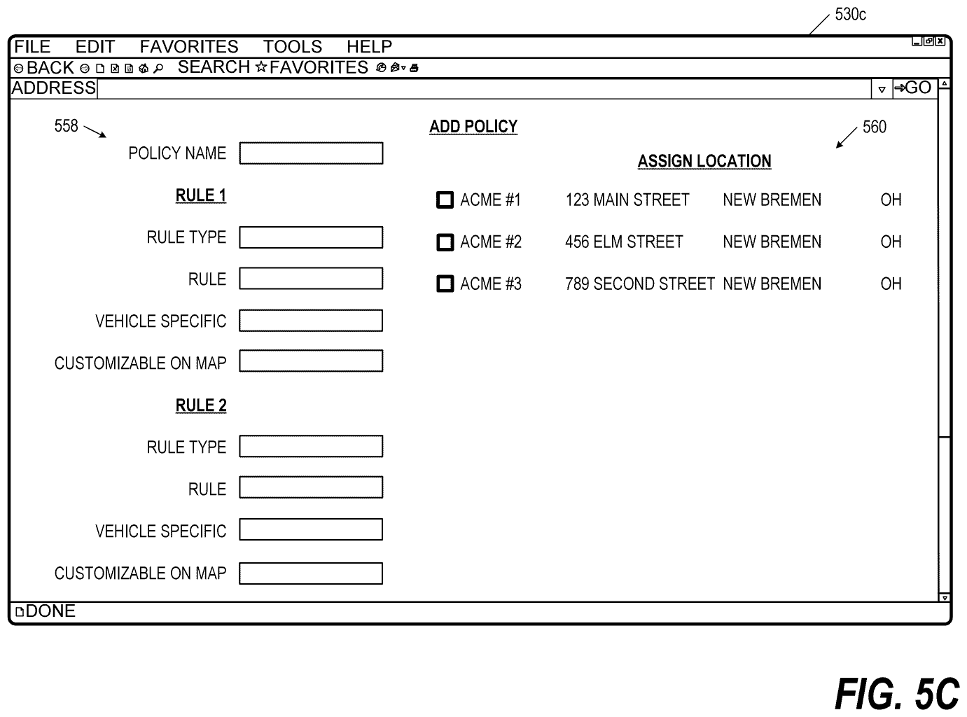

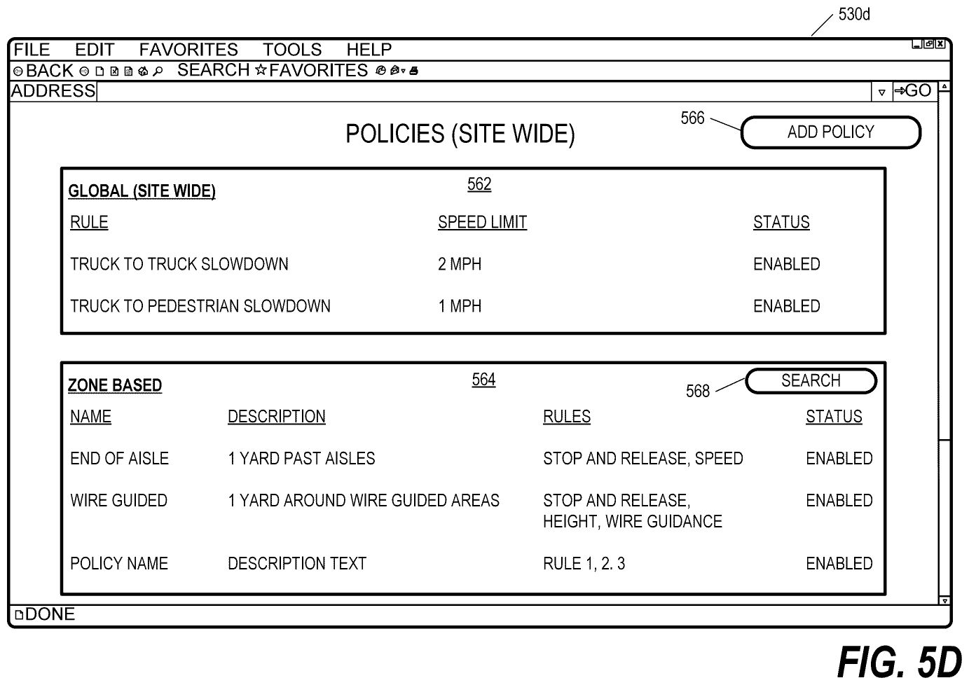

FIG. 5A depicts a user interface 530a for defining zone policies, according to embodiments provided herein. As illustrated, the user interface 530 includes a listing of zones in section 532 and section 534. The section 532 represents zone 1 and depicts policy 1, with a plurality of rules for vehicle and/or vehicle types. Section 534 represents zone 2 and depicts policy 2 and policy 3, each with different rules. As illustrated, policy 2 includes edge-based rules, which will be described in more detail below. Also provided in the user interface is a map section 536. The map section 536 depicts locations and sizes of zone 1, zone 2, and zone 3 in the covered environment 102. The map section 536 may also provide live locations of one or more vehicles 104, 304 in the covered environment 102.

Referring back to the section 534, policy 2 and policy 3 may be assigned to zone 2. Specifically, policy 2 may define edge specific rules to zone 2. Edge specific rules may provide different restrictions to a vehicle or vehicle type, depending on where and/or from which direction the vehicle 104 enters zone 2. Some embodiments may be configured to apply to all vehicles uniformly. In the example of FIG. 5A, the administrator may define the edges disposed on the sides of the map section 536 has having less of a restriction than edge 2 (depicted on the bottom of zone 2 in the map section 536) because a vehicle 104 that enters zone 2 from the sides would have a better field of vision than a vehicle 104 entering zone 2 from the bottom, as the vehicle 104 exits the aisle. Accordingly, the user of the user interface 530 may individually assign (or the remotely located computing device may automatically assign) individual rules to each edge of a restriction zone 320.

Also provided in the user interface 530a are an add site policy option 538, an add enterprise policy option 540, a combine zones option 542, a dimensions option 544, an add option 546, and a location option 548. A define zones section 550 and an edit zones option 552 may also be provided. In response to selection of the add site policy option 538, embodiments may create a new policy for an existing zone in the covered environment 102. A policy may include one or more rules that may apply to a selected zone. In some embodiments, a site policy may be created for a restriction zone 320 or type of restriction zone, but might not yet be assigned to a restriction zone 320.

Similarly, in response to selection of the add enterprise policy option 540, the user may create an enterprise policy that may be applied to one or more covered environments. As described in more detail below, the add enterprise policy option 540 may only apply to enterprise administrators that oversee a plurality of covered environments and have the credentials to direct policies across those covered environments. In response to selection of the combine zone options 542, additional options may be provided to the user for combining existing restriction zones 320. Specifically, if two restriction zones 320 are adjacent or overlapping in location, these restriction zones 320 may combined into a single restriction zone 320, where any policies and/or rules will be also combined. This combination may provide a zone shape that has more than four edges and thus may have different rules, depending on the edge that the vehicle 104 encounters to enter the restriction zone 320.

In some embodiments, merging zones causes overlapping rules and/or policies. As such, the remote computing logic 144a may cause the remote computing device 110 to determine if the policies and rules are compatible. If the policies and rules are compatible, the policies and rules may be utilized together. As an example, if zone A and zone B overlap and a combination is being combined, the remote computing device 110 may determine the rules for each of zone A and zone B. If the rules for zone A are directed to a first type of vehicle only and the rules for zone B are directed to a second type of vehicle, all of the rules may be determined to be compatible and may all be used in the combined restriction zone. If the rules and/or policies conflict, the remote computing device 110 may determine which rules will apply to the combined restriction zone. Some embodiments may receive user input. Some embodiments may utilize the most restrictive rules, the least restrictive rules, the most commonly applied rules, and/or other criteria.

In response to selection of the dimensions option 544, dimensions of a restriction zone 320 may be provided and/or edited. In response to selection of the add option 546 additional restriction zones may be added to the map section 536. In response to selection of the location option 548, a different environment may be selected. In response to selection of the edit zones option 552, the user may be provided with options to edit the existing restriction zones 320.

FIG. 5B depicts a user interface 530b for providing temporal zone policies, according to embodiments provided herein. As illustrated, the user interface 530b includes an enterprise policy section 554 and a zone 2 section 556. The enterprise policy section 554 provides rules associated an enterprise policy. The zone 2 section 556 provides temporal based rules associated with policy 5 and policy 6. Specifically, the enterprise policy may be created for application to a plurality of environments. As described above, an enterprise policy may be a policy to be applied across the environments of the enterprise.

As an example, an enterprise may desire to implement a policy with a speed rule, a platform height rule, and/or a fork height rule. As an example, a first type of vehicle may not exceed 2 MPH in a pedestrian area and have a fork height limit of no more 5 feet; a second vehicle type may not exceed 4 MPH, with a height limit of no more than 6 feet. Thus, when a environment administrator is defining a pedestrian area as the restriction zone, the restriction zone will be bound by the enterprise policy. As such (and because the user interface 530b is a local administrator user interface), the add enterprise policy option 540 may be deactivated because the local administrator does not have privileges to add (or edit) an enterprise policy. In some embodiments, options may be provided for a local administrator to send an exception request to an enterprise policy. If the respective enterprise administrator agrees to grant the exception, a new restriction zone policy may be created and utilized for the environment for which the exception was requested.

Additionally, policy 5 and policy 6 for zone 2 include temporal-based rules. Specifically, by defining temporal restrictions, zone 2 may apply the temporal-based rules only during the specified times. It should be understood that the temporal-based rules may be applied with other rules that are temporal-based rules or not. This may cause an entire restriction zone 320 to only exist during certain time periods and/or could change shape, depending on the time of day.

FIG. 5C depicts a user interface 530c for providing enterprise zone policies and enterprise groups, according to embodiments provided herein. As illustrated, the user interface 530c includes a policy details section 558 and an assign location section 560. The policy details section 558 includes a policy name field for naming the new policy. Additionally, one or more rules may be created via a rule type field, rule field, a vehicle specific field, and a customizable on map field. The rule type field may receive a selection of the type of rule that is being created. Rule types may include a speed restriction, a height restriction, a temporal based designation, etc. The rule field may receive the exact field, which may depend on the selected rule type. As an example, if the rule type is a speed restriction, the rule may determine the maximum speed for the speed restriction. If the rule type is a temporal-based rule, an additional field may be provided for a sub-type, where the user can designate that the rule is a speed restriction, height restriction, etc. The vehicle specific field may allow the user to determine whether the rule will be a vehicle specific rule and thus apply only to certain vehicle types or whether the rule will apply to all vehicle types. If vehicle specific, one or more additional fields may be provided to select the vehicle type for that particular rule.

Also provided in the user interface 530c is the assign location section 560. The assign location section 560 includes one or more locations for applying the newly created policy. Depending on the embodiment, the locations provided may correspond with the entity and/or credentials of the user. As an example, if the user is an enterprise administrator of Acme Company, he/she may be provided with the ability to apply and/or enable a local administrator to apply a policy to all environments operated by Acme. If the user is a regional manager of Acme, he/she may be provided only those environments within that region.

As an example, some embodiments may be configured such that the enterprise administrator controls all covered environments of the enterprise. In these embodiments, the enterprise administrator may dictate policies, rules, and/or other instructions that the local administrators and individual environments must comply. However, some embodiments may be configured such that the local administrators and individual covered environments may dictate rules that are best for that individual covered environment. In these embodiments, the enterprise administrator may have reduced (or in some cases no) control over the policies, rules, and instructions that a local administrator defines for that respective covered environment (or covered environments).

FIG. 5D depicts a user interface 530d for defining an enterprise group, according to embodiments provided herein. As illustrated, the user interface 530d may be configured to provide a global policy section 562 and a zone-based policy area 564. In the embodiment of FIG. 5D, the global policy section 562 may provide a list of all policies and/or rules that are under the user's purview. The global policy section 562 may provide a rule, a restriction, and a status of each such rule and/or policy. The zone-based policy area 564 may provide details of restriction zones 320 and/or zone types, such as name, description, location, rules, and status.

Also provided in the user interface 530d are an add policy option 566 and a search option 568. In response to selection of the add policy option 566, options such as provided in the user interface 530c (FIG. 5C) may be provided for adding a new policy. In response to selecting the search option 568 a search of policies and/or rules may be performed.

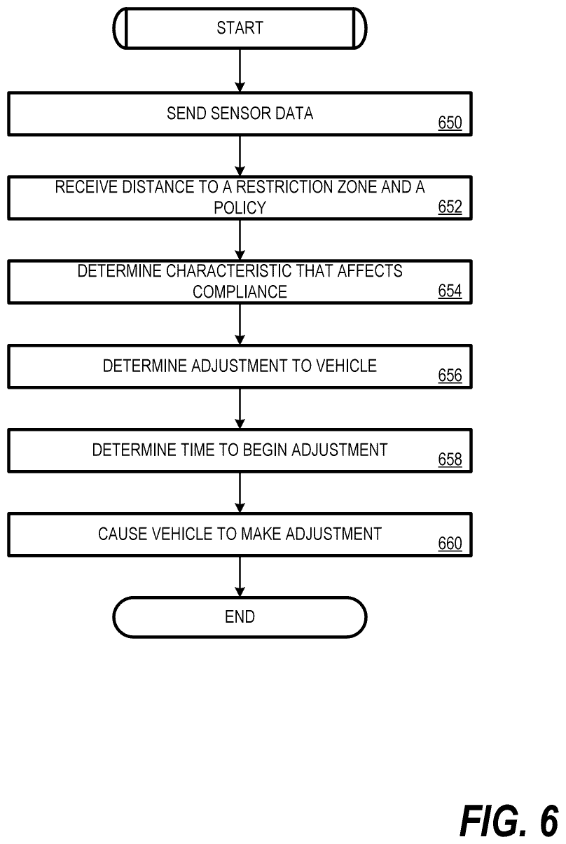

FIG. 6 depicts a flowchart for performing a zone look ahead, according to embodiments provided herein. As illustrated in block 650, sensor data may be sent, by a vehicle computing device 116 from a materials handling vehicle that operates in a covered environment 102 to a remotely located computing device. In block 652, a distance of a materials handling vehicle to a restriction zone 320 (e.g., first distance data for a first edge and/or second distance data for a second edge) and a policy (such as a speed policy, a platform height policy, a hoist speed policy, an acceleration policy, a deceleration policy, a fork height policy, etc.) of the restriction zone 320 may be received. The distance and the policy may be determined by the remotely located computing device from the sensor data. Depending on the embodiment, the restriction zone 320 may include an entrance edge and an exit edge. In block 654, a characteristic of a materials handling vehicle that affects compliance with the policy may be determined. In some embodiments, the characteristic may include a current speed, a vehicle weight, a payload weight, a deceleration rate, a vehicle type, a vehicle model, a fork maximum height, a platform height, and/or a hoist speed. In block 656, a first adjustment to current operation of the materials handling vehicle may be determined in order to comply with the policy. In block 658, a determination may be made (by the vehicle computing device 116, by the local computing device 106, the local client device 108a, and/or by a local server 108b), based on the policy and the first adjustment, a distance to begin the adjustment to comply with the policy at the entrance edge of the restriction zone 320. In some embodiments, the process may be configured as a feedback look to return to blocks 650-658. In block 660, the materials handling vehicle may be instructed to make the first adjustment to comply with the policy at the entrance edge of the restriction zone 320. Additionally, some embodiments may be configured to determine that the vehicle 104 is exiting the restriction zone 320 via an exit edge. In such embodiments, the vehicle computing device 116 further determines a second adjustment to return vehicle operation to the current operation of the materials handling vehicle at the exit edge of the restriction zone 320.

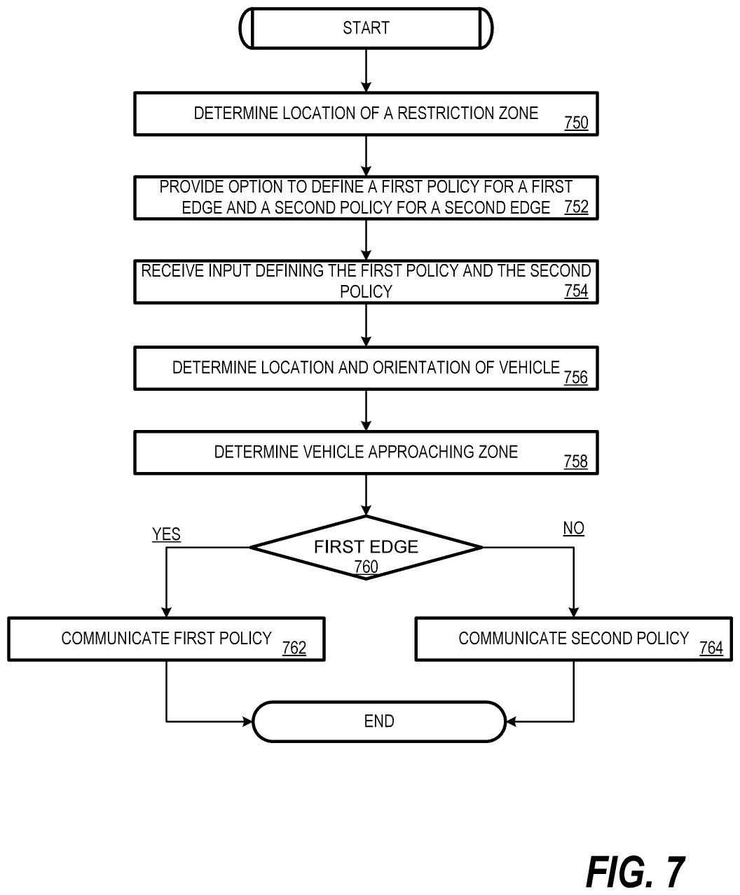

FIG. 7 depicts a flowchart for assigning entry edges to a restriction zone 320, according to embodiments provided herein. As illustrated in block 750, a location of a restriction zone 320 in the covered environment 102 may be determined. The restriction zone 320 may include a first edge and a second edge. In block 752, a user option to independently define a first policy for the materials handling vehicle when crossing into the restriction zone 320 via the first edge and a second policy for the materials handling vehicle when crossing into the restriction zone 320 via the second edge is provided. In block 754, user input defining the first policy and the second policy may be received. In block 756, a location and the orientation may be received from the materials handling vehicle. In block 758, a determination may be made regarding whether the materials handling vehicle is approaching the restriction zone 320. In block 760, a determination is made regarding whether the materials handling vehicle is approaching the restriction zone 320 via the first edge or the second edge. In block 762, in response to determining that the materials handling vehicle is approaching the restriction zone 320 via the first edge, first policy data related to the first policy may be communicated to the materials handling vehicle.

In block 764, in response to determining that the materials handling vehicle is approaching the restriction zone 320 via the second edge second policy data related to the second policy to the materials handling vehicle may be communicated to the materials handling vehicle. In some embodiments, if the materials handling vehicle is approaching the restriction zone 320 via the first edge, the materials handling vehicle adjusts current operation pursuant to the first policy data to adhere to the first policy prior to reaching the first edge and if the materials handling vehicle is approaching the restriction zone 320 via the second edge, the materials handling vehicle adjusts current operation pursuant to the second policy data to adhere to the second policy prior to reaching the second edge.

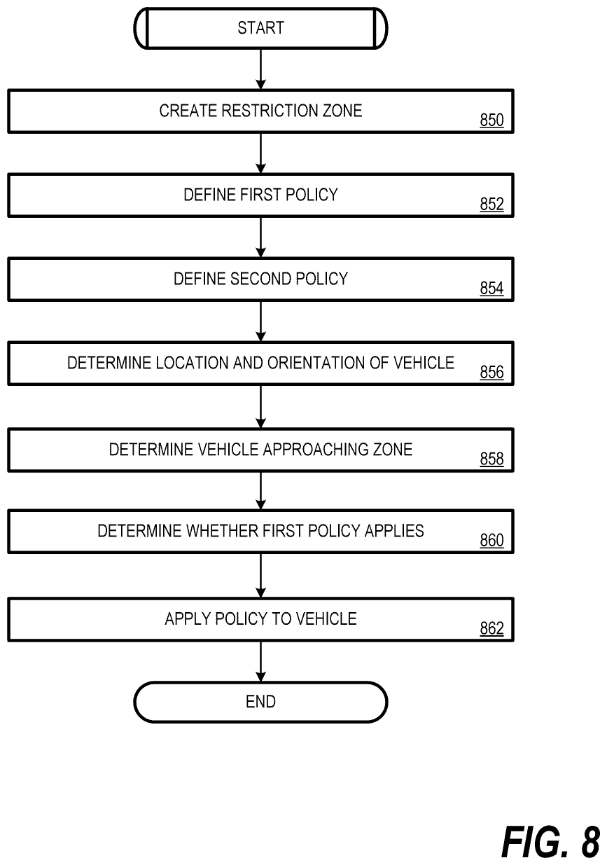

FIG. 8 depicts a flowchart for providing restriction zone 320 controls, according to embodiments provided herein. As illustrated in block 850, a first restriction zone 320 may be created for a covered environment 102. The first restriction zone 320 defines an area within which a materials handling vehicle must comply with a first policy. In block 852, the first policy may be defined. In block 854, a second policy may be defined for the first restriction zone 320. In block 856, a location and orientation of the materials handling vehicle may be determined. In block 858, a determination may be made from the location and orientation of the materials handling vehicle that the materials handling vehicle is approaching the first restriction zone. In block 860, in response to determining that the materials handling vehicle is approaching the first restriction zone, a determination may be made regarding whether the first policy applies to the materials handling vehicle. In block 862, in response to determining that the first policy applies to the materials handling vehicle, the materials handling vehicle may be sent the first policy and/or the policy may be applied to the materials handling vehicle. By sending the first policy to the materials handling vehicle, the materials handling vehicle adjusts current operation to comply with the first policy when the materials handling vehicle enters the first restriction zone.

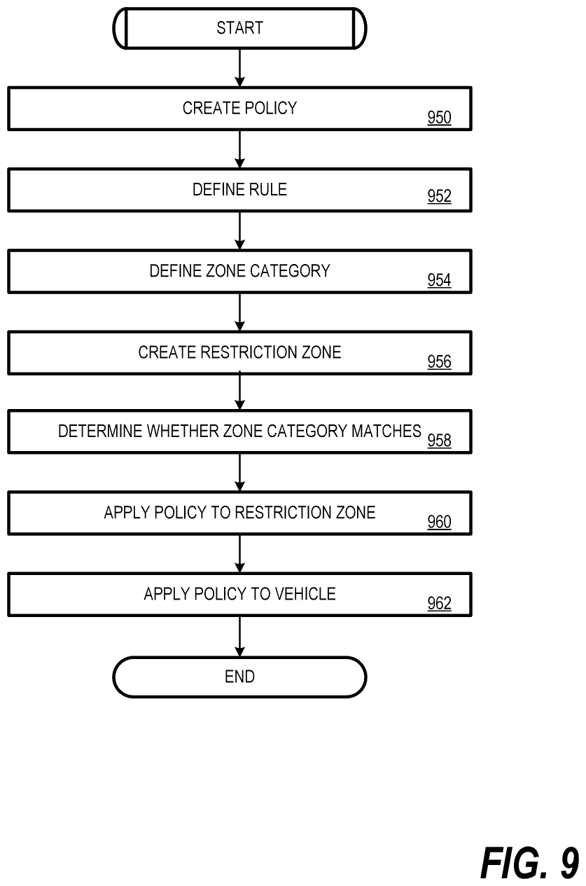

FIG. 9 depicts a flowchart for providing zones across a plurality of sites, according to embodiments provided herein. As illustrated in block 950, a first policy may be created that is available for applying to a potential restriction zone in a first covered environment and a second covered environment. Specifically, depending on the particular embodiment, an enterprise administrator may facilitate creation of the first (enterprise-wide) policy via the remote computing device 110 to potential restriction zone, which represents that the restriction zone may or may not have yet been created, but may be present in the first covered environment, the second covered environment, and/or elsewhere. In block 952, a rule for the first policy for the first policy may be defined. Depending on the particular embodiment, a policy may have one or more rules, which may apply to one or different vehicles or types of vehicles. In block 954, a zone category may be defined for the first policy. Specifically, the zone category may refer to the type of zone that the policy applies. This may include a high traffic area, a pedestrian zone, an end of aisle zone, and/or other type of zone.

In block 956, a first restriction zone may be created for the first covered environment. Creating the first restriction zone may include defining the zone category for the first restriction zone and a location for the first restriction zone. Specifically, the restriction zone may be created automatically and/or by a local administrator, such as via the local client device 108a to serve only one covered environment (or a local set of covered environments). Similarly, based on the location, size, dimensions, and/or other characteristic of the restriction zone, a determination may be made regarding the zone category for the zone. In block 958, a determination may be made regarding whether the zone category matches the zone category for the first policy. As an example, if the first policy was identified as a pedestrian zone category and the restriction zone was similarly identified, a determination may be made that the zone categories match, such that the restriction zone will utilize the first policy. Thus, in block 960, in response to determining that the zone category matches the zone category for the first policy, the first policy may be applied to the first restriction zone. In block 962, in response to determining that a materials handling vehicle is approaching the first restriction zone, the first policy may be sent to the materials handling vehicle and/or applied to the materials handling vehicle.

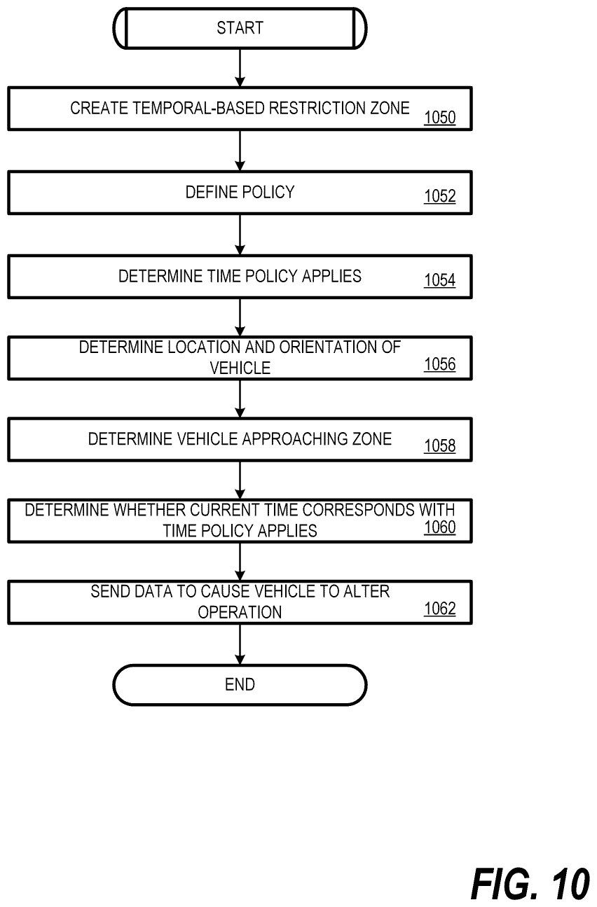

FIG. 10 depicts a flowchart for providing temporal zone policies, according to embodiments provided herein. As illustrated in block 1050, a temporal-based restriction zone 320 for a covered environment 102 may be created. In some embodiments, the temporal-based restriction zone 320 defines an area within which a materials handling vehicle must comply with a policy. In block 1052, the policy may be defined. In block 1054, a first time and/or a second time that the policy applies may be determined. In block 1056, a location and an orientation of the materials handling vehicle may be determined. In block 1058, a determination may be made from the location and the orientation, that the materials handling vehicle is approaching the temporal-based restriction zone 320. In block 1060, a determination may be made regarding whether a current time corresponds with the first time the policy applies. In block 1062, in response to determining that the materials handling vehicle is approaching the temporal-based restriction zone 320 at the first time the policy applies, data related to the policy may be sent to the materials handing vehicle. This may cause the materials handling vehicle to adjust operation to comply with the policy when the materials handling vehicle enters the temporal-based restriction zone 320.

In some embodiments, the other criteria may include a pedestrian congestion of a predefined area around the temporal-based restriction zone 320, a vehicle congestion of the predefined area around the temporal-based restriction zone 320, a condition of the materials handling vehicle, a skill level of an operator of the materials handling vehicle, etc. Similarly, in response to determining that the materials handling vehicle is approaching the temporal-based restriction zone 320 at a different time than the first time the policy applies, some embodiments allow the materials handling vehicle to enter the temporal-based restriction zone 320 without interference.

Similarly, some embodiments may be configured such that the policy includes a time variable component that applies a first rule and/or a second rule (such as a speed rule, a platform height rule, a fork height rule, etc.) of the policy if the materials handling vehicle enters the temporal-based restriction zone 320 during the first time, only if another criteria is met. As an example, the other criteria may include a pedestrian congestion of a predefined area around the temporal-based restriction zone 320, a vehicle congestion of the predefined area around the temporal-based restriction zone 320, a condition of the materials handling vehicle, or a skill level of an operator of the materials handling vehicle. As such, the temporal-based restriction zone 320 may apply during the specified time, unless the pedestrian congestion and/or vehicle congestion in the area is below a predetermined threshold. In some embodiments, if the skill level of the vehicle operator is above a predetermined threshold, the temporal-based restriction zone 320 may not be applied. In some embodiments, if the vehicle 104 meets a predetermined operational threshold the restriction zone 320 may not be applied. It should also be understood that while the time variable component may be binary (e.g., on or off), some embodiments may be configured with a tiered configuration such that restrictions may be lessened if vehicle congestion is at a first level, lessened more if vehicle congestion is at a second (lesser) level.

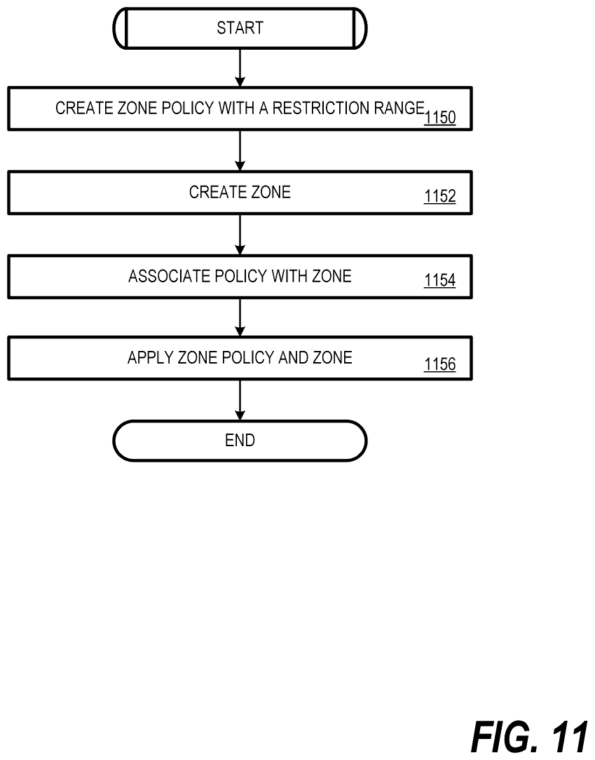

FIG. 11 depicts a flowchart for providing range-based enterprise zones, according to embodiments provided herein. As illustrated in block 1150, a first restriction zone 320 policy may be created for a plurality of covered environments. The first restriction zone 320 policy defines a first rule with a restriction range on a hypothetical materials handling vehicle that is located in a restriction zone 320 in at least one of the plurality of covered environments. In block 1152, a first restriction zone 320 may be created for a first covered environment 102. In some embodiments, creating the first restriction zone 320 includes defining a first dimension of the first restriction zone 320 and a first location in the first covered environment 102 of the first restriction zone 320. In block 1154, the first restriction zone 320 policy may be associated with the first restriction zone 320. It will be understood that associating the first restriction zone 320 policy with the first restriction zone 320 may include defining a first value within the restriction range for the first rule. In block 1156, the restriction zone 320 and the first restriction zone 320 policy may be applied to the location in the first covered environment 102.

In some embodiments, a determination may be made that the vehicle 104 is entering the restriction zone 320. In response, the remotely located computing device may be configured to apply the first rule to restrict operation of the materials handling vehicle once the materials handling vehicle enters the restriction zone 320. Some embodiments may be configured to create a second restriction zone 320 for a second covered environment 102. Creating the second restriction zone 320 may include defining a second location in the second covered environment 102 of the second restriction zone 320. A third policy may also be defined for the second restriction zone. In these embodiments, the first restriction zone 320 policy may be associated with the second restriction zone 320, where associating the first restriction zone 320 policy to the second restriction zone 320 includes defining a second value within the restriction range for the first rule. Some embodiments may apply the second restriction zone 320 and the first restriction zone 320 policy to the second location in the second covered environment 102. Some embodiments may create a second restriction zone 320 for a second covered environment 102. Creating the second restriction zone 320 may include defining a second dimension of the second restriction zone 320 and a second location in the second covered environment 102 of the second restriction zone 320. These embodiments may associate the first restriction zone 320 policy with the second restriction zone 320, where associating the first restriction zone 320 policy with the second restriction zone 320 includes defining a second value within the restriction range for the first rule. Embodiments may apply the second restriction zone 320 and the first restriction zone 320 policy to the second location in the second covered environment 102.

Similarly, some embodiments may be configured to receive an exception request to the restriction range for the first covered environment 102. These embodiments may further receive a response to the exception request, determine whether the response to the exception request grants an exception. In response to determining that the response to the exception request grants the exception, a new restriction zone 320 policy may be created with the exception incorporated. Some embodiments may implement the new restriction zone 320 policy in the first covered environment 102.

FIG. 12 depicts the remote computing device 110, according to embodiments provided herein. As illustrated, the remote computing device 110 includes a processor 1230, input/output hardware 1232, a network interface hardware 1234, a data storage component 1236 (which stores vehicle data 1238a, premises data 1238b, and/or other data), and a memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable medium. Depending on the particular embodiment, these non-transitory computer-readable mediums may reside within the remote computing device 110 and/or external to the remote computing device 110.

The memory component 140 may store operating logic 1242, the remote computing logic 144a and the vehicle location logic 144b. Each of these logic components may include a plurality of different pieces of logic, each of which may be embodied as a computer program, firmware, and/or hardware, as an example. A local interface 1246 is also included in FIG. 12 and may be implemented as a bus or other communication interface to facilitate communication among the components of the remote computing device 110.

The processor 1230 may include any processing component operable to receive and execute instructions (such as from a data storage component 1236 and/or the memory component 140). As described above, the input/output hardware 1232 may include and/or be configured to interface with speakers, microphones, and/or other input/output components.

The network interface hardware 1234 may include and/or be configured for communicating with any wired or wireless networking hardware, including an antenna, a transceiver, a modem, a LAN port, wireless fidelity (Wi-Fi) card, WiMAX card, mobile communications hardware, and/or other hardware for communicating with other networks and/or devices. From this connection, communication may be facilitated between the remote computing device 110 and other computing devices.

The operating logic 1242 may include an operating system and/or other software for managing components of the remote computing device 110. As discussed above, the remote computing logic 144a may be configured to cause the processor 1230 to provide user interfaces to allow a user to define zones, as well as illustrate the covered environment 102, as described herein. The vehicle location logic 144b may be configured to cause the processor 1230 to utilize transceiver anchors and/or other technologies to determine a location of the vehicle 104 in the covered environment 102.

It should be understood that while the components in FIG. 12 are illustrated as residing within the remote computing device 110, this is merely an example. In some embodiments, one or more of the components may reside external to the remote computing device 110 or within other devices, such as the vehicle 104, the local client device 108a, and/or the local server 108b depicted in FIGS. 1A, 1B. It should also be understood that, while the remote computing device 110 is illustrated as a single device, this is also merely an example. In some embodiments, the remote computing logic 144a and/or the vehicle location logic 144b may reside on different computing devices.

As an example, one or more of the functionalities and/or components described herein may be provided by the remote computing device 110, the vehicle 104, the local client device 108a, and/or the local server 108b. Depending on the particular embodiment, any of these devices may have similar components as those depicted in FIG. 12. To this end, any of these devices may include logic for performing the functionality described herein.

Additionally, while the remote computing device 110 is illustrated with the remote computing logic 144a and the vehicle location logic 144b as separate logical components, this is also an example. In some embodiments, a single piece of logic may provide the described functionality. It should also be understood that while the remote computing logic 144a and the vehicle location logic 144b are described herein as the logical components, this is also an example. Other components may also be included, depending on the embodiment.

As illustrated above, various embodiments are disclosed. These embodiments may be configured to create and implement shaped detection fields around a vehicle 104, such as a materials handling vehicle. These embodiments improve the functioning of a materials handling vehicle by customizing these virtual shaped detection fields that the materials handling vehicle utilizes to automatically and without user input adjust operation.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for systems and methods for shaped detection fields. It should also be understood that these embodiments are merely exemplary and are not intended to limit the scope of this disclosure.

What is claimed is:

1. A system comprising:
a materials handling vehicle in an covered environment that includes a vehicle transceiver for determining a location of the materials handling vehicle in the covered environment, a vehicle sensor for detecting an orientation of the materials handling vehicle and a vehicle computing device;
a remotely located computing device that includes a processor and a memory component, the memory component storing logic that, when executed by the processor, causes the system to perform at least the following:
determine a location of a restriction zone in the covered environment, wherein the restriction zone includes a first edge and a second edge;
provide a user option to independently define a first policy for the materials handling vehicle when crossing into the restriction zone via the first edge and a second policy for the materials handling vehicle when crossing into the restriction zone via the second edge;
receive user input defining the first policy and the second policy;
determine the location and the orientation from the materials handling vehicle;
determine, from the location and the orientation, that the materials handling vehicle is approaching the restriction zone via the first edge or the second edge;
in response to determining that the materials handling vehicle is approaching the restriction zone via the first edge, communicate first policy data related to the first policy to the materials handling vehicle; and
in response to determining that the materials handling vehicle is approaching the restriction zone via the second edge, communicate second policy data related to the second policy to the materials handling vehicle,
wherein, if the materials handling vehicle is approaching the restriction zone via the first edge, the materials handling vehicle adjusts current operation pursuant to the first policy data to adhere to the first policy prior to reaching the first edge and if the materials handling vehicle is approaching the restriction zone via the second edge, the materials handling vehicle adjusts current operation pursuant to the second policy data to adhere to the second policy prior to reaching the second edge.

2. The system of claim 1, wherein in response to determining that the materials handling vehicle is approaching the restriction zone via the first edge, the logic causes the system to send first distance data related to a distance from the first edge to the materials handling vehicle, and wherein in response to determining that the materials handling vehicle is approaching the restriction zone via the second edge, the logic causes the system to send second distance data related to a distance from the second edge to the materials handling vehicle.

3. The system of claim 1, wherein the vehicle sensor includes at least one of the following: a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a RADAR system, a SONAR system, or a camera system.

4. The system of claim 1, wherein the vehicle transceiver includes an ultra wide band (UWB) antenna that communicates with a plurality of UWB transceiver anchors that are fixed to stationary objects in the covered environment for detecting the location of the materials handling vehicle in the covered environment.

5. The system of claim 1, wherein the first policy includes at least one of the following: a speed policy, a carriage height policy, a hoist speed policy, an acceleration policy, a deceleration policy, or a fork height policy.

6. The system of claim 1, wherein in response to determining that the materials handling vehicle will enter the restriction zone via the first edge, the materials handling vehicle determines a first policy associated with a deceleration rate and utilizes first policy data that includes the deceleration rate to determine when to start decelerating to comply with the first policy by the first edge.

7. The system of claim 6, wherein the materials handling vehicle further determines at least one of the following in determining the deceleration rate: a payload weight of a payload carried by the materials handling vehicle, a vehicle type of the materials handling vehicle, or a weight of the materials handling vehicle.

8. The system of claim 1, wherein the remotely located computing device includes at least one of the following: a local computing device that resides in the covered environment and a remote computing device that resides remote from the covered environment.

9. The system of claim 1, wherein the user option is provided as part of a user interface that includes an add option to perform at least one of the following: add additional restriction zones in the covered environment or add new policies for other edges.

10. The system of claim 1, wherein the first policy provides a default characteristic that the materials handling vehicle will comply, even after the materials handling vehicle exits the restriction zone and wherein the second policy removes the default characteristic when the materials handling vehicle crosses the second edge.

11. A method comprising:
determining, by a computing device, a location of a restriction zone in a covered environment, wherein the restriction zone includes a first edge and a second edge;
providing, by the computing device, a user option to independently define a first policy for a materials handling vehicle when crossing into the restriction zone via the first edge and a second policy for the materials handling vehicle when crossing into the restriction zone via the second edge;
receiving, by the computing device, user input defining the first policy and the second policy;
determining, by the computing device, a location and an orientation from the materials handling vehicle;
determining, by the computing device, from the location and the orientation, that the materials handling vehicle is approaching the restriction zone via the first edge or the second edge;
in response to determining that the materials handling vehicle is approaching the restriction zone via the first edge, communicating, by the computing device, first policy data related to the first policy to the materials handling vehicle; and
in response to determining that the materials handling vehicle is approaching the restriction zone via the second edge, communicating, by the computing device, second policy data related to the second policy to the materials handling vehicle,
wherein, if the materials handling vehicle is approaching the restriction zone via the first edge, the materials handling vehicle adjusts current operation pursuant to the first policy data to adhere to the first policy prior to reaching the first edge and if the materials handling vehicle is approaching the restriction zone via the second edge, the materials handling vehicle adjusts current operation pursuant to the second policy data to adhere to the second policy prior to reaching the second edge.

12. The method of claim 11, further comprising:
in response to determining that the materials handling vehicle is approaching the restriction zone via the first edge, sending first distance data related to a distance from the first edge to the materials handling vehicle; and
in response to determining that the materials handling vehicle is approaching the restriction zone via the second edge, sending second distance data related to a distance from the second edge to the materials handling vehicle.

13. The method of claim 11, wherein the orientation is determined via at least one vehicle sensor that includes at least one of the following: a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a RADAR system, a SONAR system, or a camera system.

14. The method of claim 11, wherein determining the location includes communicating with an ultra wide band (UWB) antenna on the materials handling vehicle that communicates with a plurality of UWB transceiver anchors that are fixed to stationary objects in the covered environment for detecting the location of the materials handling vehicle in the covered environment.

15. The method of claim 11, wherein the first policy includes at least one of the following:
a speed policy, a carriage height policy, a hoist speed policy, an acceleration policy, a deceleration policy, or a fork height policy.

16. The method of claim 11, wherein in response to determining that the materials handling vehicle will enter the restriction zone via the first edge, the materials handling vehicle determines a first policy associated with a deceleration rate and utilizes first policy data that includes the deceleration rate to determine when to start decelerating to comply with the first policy by the first edge.

17. The method of claim 16, wherein the materials handling vehicle further determines at least one of the following in determining the deceleration rate: a payload weight of a payload carried by the materials handling vehicle, a vehicle type of the materials handling vehicle, or a weight of the materials handling vehicle.

18. A system comprising:
a remotely located computing device that includes a processor and a memory component, the memory component storing logic that, when executed by the processor, causes the system to perform at least the following:
determine a location of a restriction zone in a covered environment, wherein the restriction zone includes a first edge and a second edge;
provide a user option to independently define a first policy for a materials handling vehicle when crossing into the restriction zone via the first edge and a second policy for the materials handling vehicle when crossing into the restriction zone via the second edge;
receive user input defining the first policy and the second policy;
determine a location and an orientation from data received from the materials handling vehicle;
determine, from the location and the orientation, that the materials handling vehicle is approaching the restriction zone via the first edge or the second edge;
in response to determining that the materials handling vehicle is approaching the restriction zone via the first edge, communicate first policy data related to the first policy to the materials handling vehicle; and
in response to determining that the materials handling vehicle is approaching the restriction zone via the second edge, communicate second policy data related to the second policy to the materials handling vehicle,
wherein, if the materials handling vehicle is approaching the restriction zone via the first edge, the materials handling vehicle adjusts current operation pursuant to the first policy data to adhere to the first policy prior to reaching the first edge and if the materials handling vehicle is approaching the restriction zone via the second edge, the materials handling vehicle adjusts current operation pursuant to the second policy data to adhere to the second policy prior to reaching the second edge.

19. The system of claim 18, wherein:
the materials handling vehicle includes a vehicle transceiver for determining the location of the materials handling vehicle in the covered environment,
the vehicle transceiver includes an ultra wide band (UWB) antenna that communicates with a plurality of UWB transceiver anchors that are fixed to stationary objects in the covered environment for detecting the location of the materials handling vehicle in the covered environment,
the materials handling vehicle includes a vehicle sensor for detecting the orientation of the materials handling vehicle and a vehicle computing device, and
the vehicle sensor includes at least one of the following: a light detection and ranging (LiDAR) sensor, a wheel speed sensor, a weight sensor, a steer angle sensor, an odometer, a wireline sensor, a gyroscope, an accelerometer, an onboard inertial measurement unit (IMU), a radio frequency identifier (RFID), a magnet, and/or other technology, 2-dimensional LiDAR system, a 3-dimensional LiDAR system, a RADAR system, a SONAR system, or a camera system.

20. The system of claim 18, wherein the user option is provided as part of a user interface that includes an add option to perform at least one of the following: add additional restriction zones in the covered environment or add new policies for other edges.
